(19) United States
(12) Patent Application Publication
(10) Pub. No.: US 2012/0190473 A1
(43) Pub. Date: Jul. 26, 2012

(54) VARIABLE STIFFNESS SPORTS EQUIPMENT

(76) Inventor: Jason Swist, Edmonton (CA)

(21) Appl. No.: 13/295,122

(22) Filed: Nov. 14, 2011

Related U.S. Application Data
(60) Provisional application No. 61/436,225, filed on Jan. 26, 2011.

(51) Int. Cl. A63B 53/00; A63B 59/14; A63B 59/00; B23P 11/00

(52) U.S. Cl. 473/282; 29/428; 473/560; 473/564

(57) ABSTRACT

Many sports rely upon the use by the sportsperson of one or more pieces of sports equipment such as bats, rackets, clubs, boards etc. Typically these items of sports equipment employ a shaft having predetermined geometry and properties established by the materials used to manufacture the equipment. However, the sportsperson typically uses these over a wide range of conditions rather than a narrow range that provides constraints on the design of conventional sports equipment. According to embodiments of the invention sports equipment are implemented with multiple elements within the shaft such that the stiffness of the item varies with induced flexure arising from use. As such under one range of motion the item exhibits stiffness characterized by a first Young's modulus and under a second range of motion the item exhibits stiffness characterized by a second Young's modulus.

### CROSS-REFERENCE TO RELATED APPLICATIONS

This patent application claims the benefit of U.S. Provisional Patent Application U.S. 61/436,255 filed Jan. 26, 2011 entitled “Variable Stiffness Sports Equipment.”

### FIELD OF THE INVENTION

This invention relates to sports equipment and more specifically to variable stiffness of elements of said sports equipment that experience flexure.

### BACKGROUND OF THE INVENTION

Golf is a popular game not only in the US but also many parts of the world such as Korea, Japan, India, China, Germany, UK and South Africa. Within the last 5 years, the golf industry has seen a significant growth of 5-15% annually at various regions of the world. According to a recent market study “Opportunities in the Global Golf Club Market 2004-2009” published by E-Composites, Inc., the golf club market in India and China will continue to see a growth rate of over 25% annually for the period 2010-2014. The growing popularity of the game and the general affluence of golfers ensure a substantial market, which in 2010 was estimated US $3.9 billion.

The market for manufacturers of golf clubs/golf shafts is crowded with small to large corporations such as Callaway, Taylonnade, Acushnet, Ping Golf and Wilson. There are more than 100 manufacturers of golf clubs around the world and about 50 of these golf clubs/shafts manufacturers are in the USA. Suppliers of golf clubs/shafts are mostly based in the US, China, Taiwan, Korea, Japan, UK, and Germany.

Considering Callaway, one of the industry leaders, then in 2008 sales were divided between woods (24%), irons (27.6%), putters (9.1%), balls (20%), and other accessories (19.3%). With annual revenues of US $1,100 million in 2008 and US $950 million in 2009 woods, irons, and putters together accounted for approximately 60% of their revenue, US $1,230 million for the two years.

Over the years golf club manufacturers have released hundreds of new models featuring variations in the design of many elements of the golf clubs including hosel profile, heel, top line, toe, face, back, back cavity, sole, weighting for the head alone together with introducing steel variations, titanium and carbon fiber materials for the shafts, and weight, geometry, and polymeric materials for the grip that slides onto the upper portion of the shaft. Despite the massive research and development efforts, brand profiles built upon world renowned figures over the past decades such as Tiger Woods, Jack Nicklaus, Greg Norman, Seve Ballesteros, and Fred Couples the fundamental assembly of golf clubs has not changed for a century since the Thomas Horsburgh experimented with steel shafts in the late 1890s.

Likewise in other sports significant research and developments by major global brands such as Adidas, Nike, Reebok, Dunlop, Head and Wilson as well as multiple other manufacturers, including but not limited to, CCM, Mission, Sherwood, Easton, Rosignol, Saloman, Burton, Head, Yonex, Victor, Joobong, ProKennex have continued to impress upon sportsmen and women globally a continuing evolution in technology as new products are released annually. Sponsorships with internationally recognized sports personalities including for example Sidney Crosby, Alex Ovechkin, Henrik and Daniel Sedin, Rafael Nadal, Roger Federer, Maria Sharapova, Venus and Serena Williams, Shaun White, Torah Bright, Kelly Clark, Hermann Maier, and Bode Miller further associate greatness with particular brands. Overall in 2009 approximately $75 billion was spent on sports equipment out of an overall market for sports equipment, apparel and footwear of approximately $280 billion.

In many sports, including for example tennis, golf, badminton, and ice hockey the equipment be it a stick or racket has a shaft has inserted onto one end a grip and onto the other end the head. In others, snowboard and skiing for example the equipment is a long flat section with shaped from and rear sections, and defined edges along the length. In all though the particular materials, their thicknesses, composition, and even orientation results in these items of equipment providing a predetermined strength and rigidity either along the length of the item or transversely. In some instances these transverse are further engineered to vary in two or more predefined directions relative to the cross-section of the item of equipment.

However, the user in playing their particular sport may use the item of equipment over a wide range of effective motions. For example, a tennis player may wish to impart high speed during a serve or smash yet remove speed in a drop shot. Likewise a hockey player wishes to vary their shot from a gentle tap through passing to shots and slap shots. A golfer may be seeking to drive the ball as far as possible with one driver or may be seeking to finesse a driving shot that does require full swing, lob the ball a short distance or a long distance.

Accordingly, the properties of their sports equipment are predetermined through the particular construction the manufacturer has used. There is no variation between how the equipment essentially behaves under one set of conditions, e.g. low flexure during a slow shot, where low rigidity may be beneficial for example to another set of conditions, e.g. high flexure during a fast shot, where high rigidity may be beneficial or vice-versa. It would be beneficial therefore to provide elements of sports equipment, for example golf club shaft, hockey stick shaft, skate board, which exhibited properties that varied with the particular conditions of use. According to embodiments of the invention such a variation of characteristics of elements of sports equipment with the conditions of their usage is provided.

### SUMMARY OF THE INVENTION

It is an object of the present invention to obviate or mitigate at least one disadvantage of the prior art.

In accordance with an embodiment of the invention there is provided a method comprising providing a component comprising a shaft of length substantially larger than its lateral dimensions having at one end a handle and at the other distal end a head, the shaft comprising an outer body formed from a first material characterized by at least a first Young's modulus and an inner body formed from a second material characterized by at least a second Young's modulus, wherein the outer body has a length at least one of equal to and greater than the inner body and is separated from the inner body over a predetermined portion of the length of the shaft such that the shaft exhibits a first stiffness under first motion of the component and a second stiffness under second motion of the component.

In accordance with another embodiment of the invention there is provided a device comprising a handle, a head, and a shaft of length substantially larger than its lateral dimensions having at one end the handle and at the other distal end the head. The shaft comprising an outer body formed from a first material characterized by at least a first Young's modulus and an inner body formed from a second material characterized by at least a second Young's modulus, wherein the outer body has a length at least one of equal to and greater than the inner body and is separated from the inner body over a predetermined portion of the length of the shaft such that the shaft exhibits a first stiffness under first motion of the component and a second stiffness under second motion of the component.

In accordance with another embodiment of the invention there is provided a method comprising providing a shaft of length substantially larger than its lateral dimensions to support at one end a handle and at the other distal end a head. The shaft comprising an outer body formed from a first material characterized by at least a first Young's modulus and an inner body formed from a second material characterized by at least a second Young's modulus, wherein the outer body has a length at least one of equal to and greater than the inner body and is separated from the inner body over a predetermined portion of the length of the shaft such that the shaft exhibits a first stiffness under first motion of the component and a second stiffness under second motion of the component.

In accordance with another embodiment of the invention there is provided a device comprising a shaft of length substantially larger than its lateral dimensions to support at one end a handle and at the other distal end a head. The shaft comprising an outer body formed from a first material characterized by at least a first Young's modulus and an inner body formed from a second material characterized by at least a second Young's modulus, wherein the outer body has a length at least one of equal to and greater than the inner body and is separated from the inner body over a predetermined portion of the length of the shaft such that the shaft exhibits a first stiffness under first motion of the component and a second stiffness under second motion of the component.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a method of manufacturing a golf club shaft according to the prior art of Jackson in US Patent Application 2002/0119830;

FIG. 1B depicts a method of manufacturing a golf club shaft according to the prior art of Smith et al in U.S. Pat. No. 6,132,323;

FIG. 1C depicts a method of manufacturing a golf club shaft according to the prior art of Jackson in U.S. Pat. No. 5,788,585;

FIG. 1D depicts a method of manufacturing a golf club shaft according to the prior art of Tennent et al in U.S. Pat. No. 5,265,872;

FIG. 1E depicts methods of manufacturing a golf club shaft according to the prior art of Blough and Renard in U.S. Pat. Nos. 6,845,552 and 5,397,636 respectively;

FIG. 1F depicts a method of manufacturing a golf club shaft according to the prior art of Swinford in U.S. Pat. No. 5,873,793;

FIG. 2 depicts typical golf club shafts according to the prior art and providing decoration according to the prior art of Watanabe in U.S. Pat. No. 5,397,636;

FIG. 3A depicts sports equipment for different sports that employ a shaft of typically circular cross-section;

FIG. 3B depicts sports equipment for different sports that employ typical golf grips according to the prior art;

FIG. 4 depicts an embodiment of the invention wherein a golf club head and shaft are aligned through their mating interfaces in a predetermined orientation;

FIG. 5A depicts an embodiment of the invention wherein an alternative coupling method is provided with unique orientation keying;

FIG. 5B depicts an embodiment of the invention employing inserts into the shaft of an item of sports equipment to provide a keyed recess for aligning another element of the item of sports equipment;

FIG. 6A depicts shafts for an item of sports equipment according to embodiments of the invention;

FIG. 6B depicts the resulting effect on the central section L3A or L3B of the first and second shafts 600A and 600B under increasing flexure of the respective shaft;

FIG. 7 depicts a shaft for an item of sports equipment according to an embodiment of the invention;

FIG. 8 depicts a shaft for an item of sports equipment according to an embodiment of the invention;

FIG. 9 depicts a shaft for an item of sports equipment according to an embodiment of the invention;

FIG. 10 depicts a shaft for an item of sports equipment according to an embodiment of the invention;

FIG. 11 depicts a body of an item of sports equipment according to an embodiment of the invention;

FIG. 12 depicts a body of an item of sports equipment according to an embodiment of the invention;

FIG. 13 depicts a shaft for an item of sports equipment according to an embodiment of the invention;

FIG. 14 depicts a shaft for an item of sports equipment according to an embodiment of the invention;

FIG. 15 depicts a shaft for an item of sports equipment according to an embodiment of the invention;

FIG. 16 depicts a shaft for an item of sports equipment according to an embodiment of the invention; and

FIG. 17 depicts a shaft for an item of sports equipment according to an embodiment of the invention.

### DETAILED DESCRIPTION

The present invention is directed to sports equipment and more specifically to variable stiffness of elements of said sports equipment that experience flexure.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

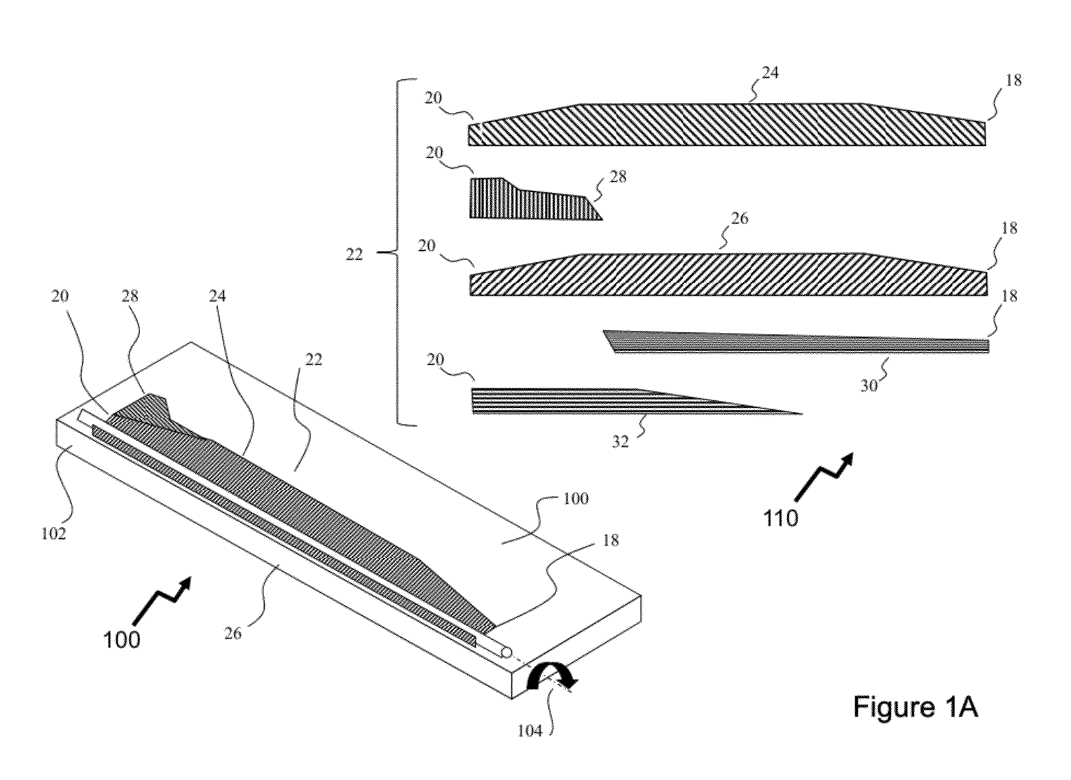

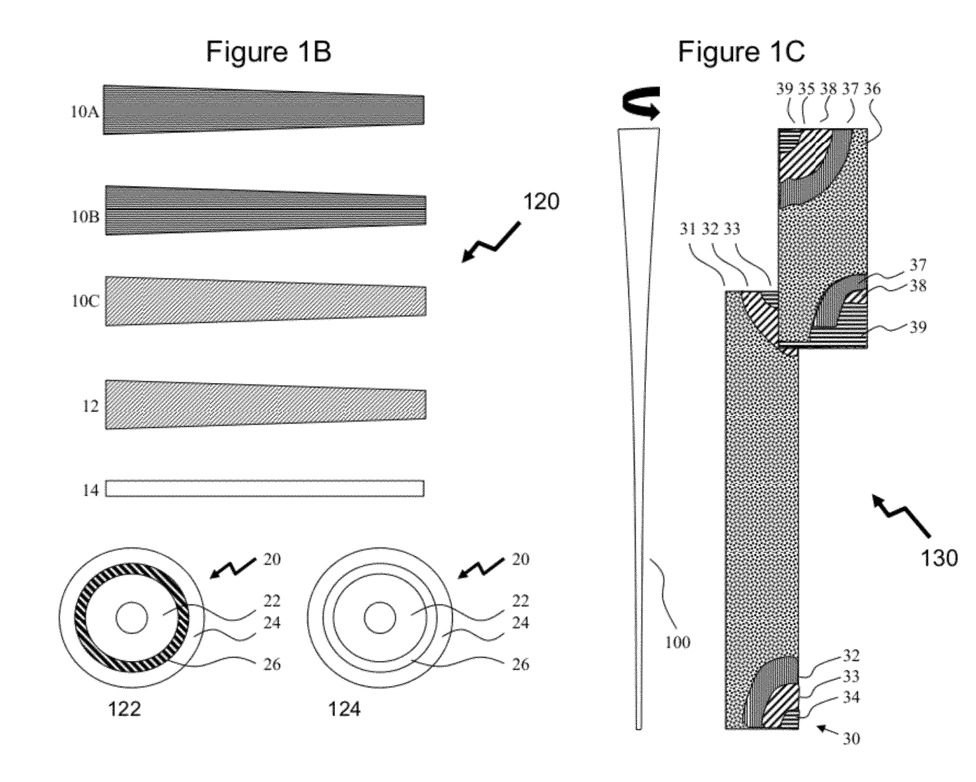

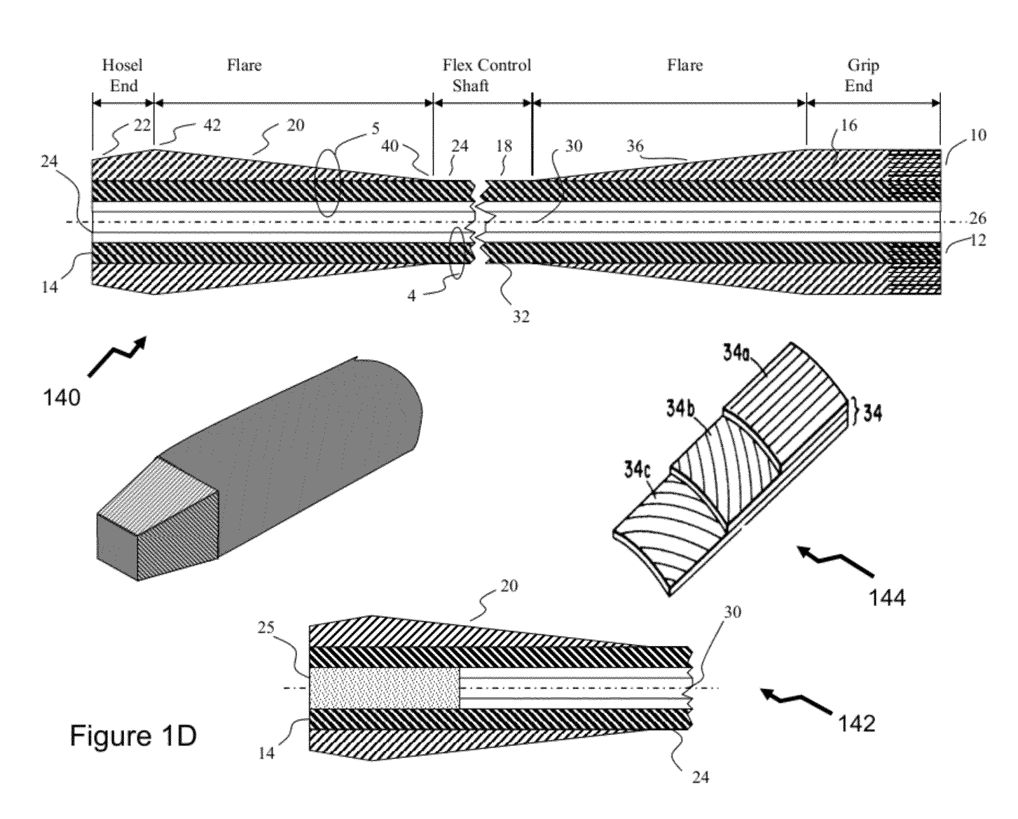

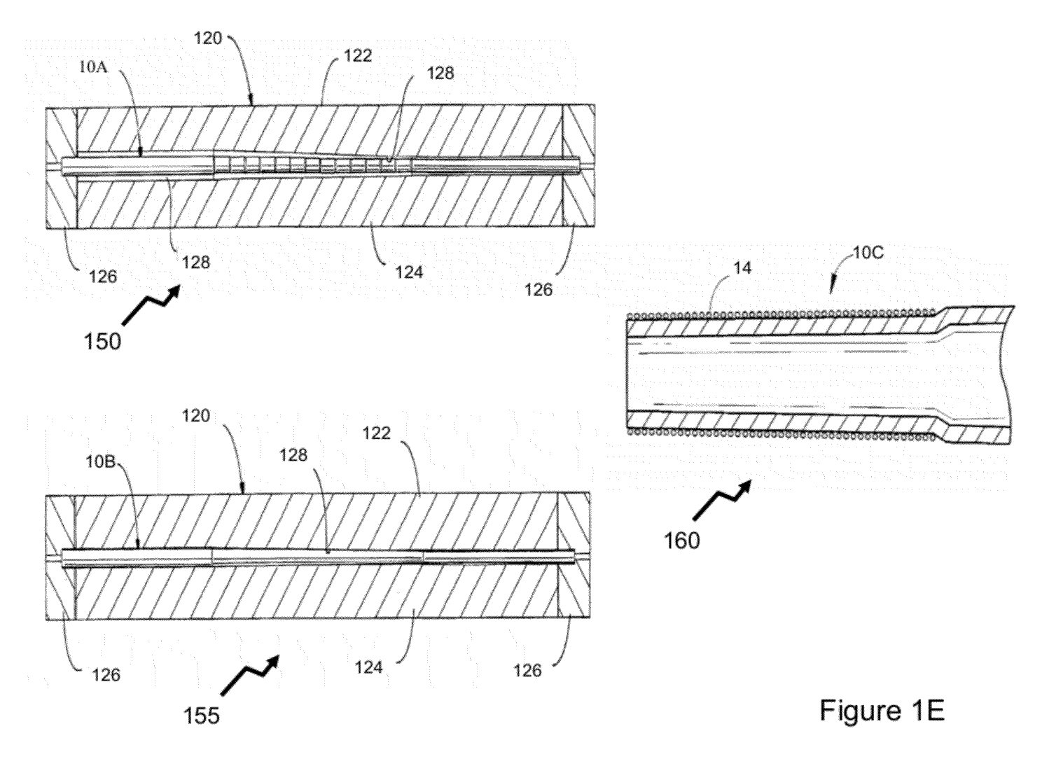

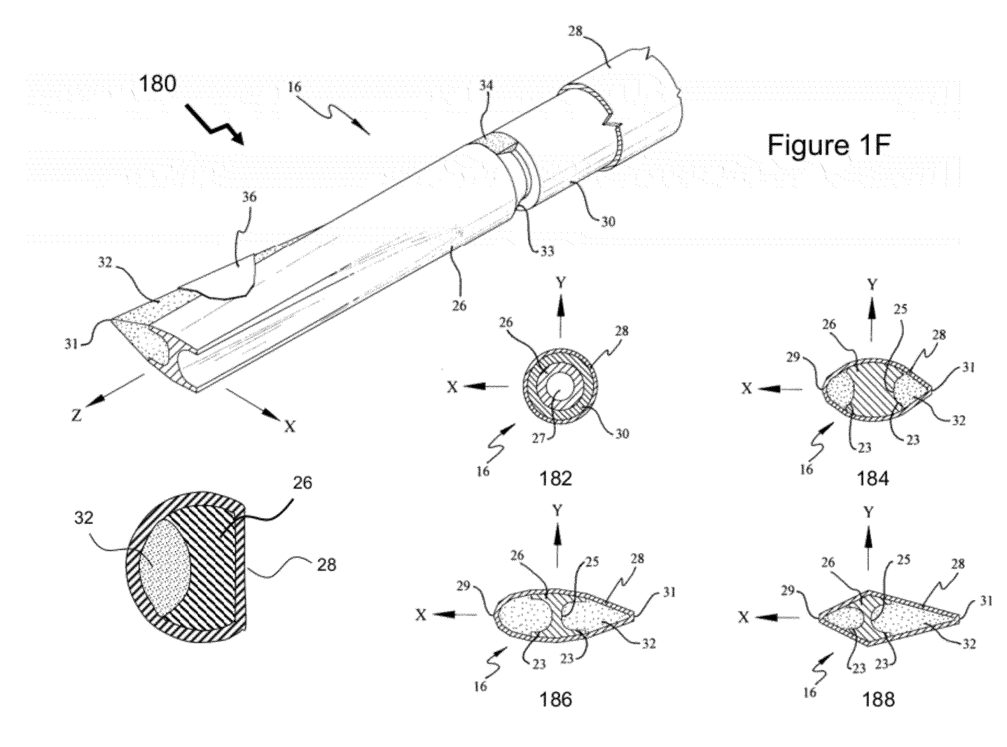

Referring to FIG. 1A there is depicted a method of manufacturing a golf club shaft according to the prior art of Jackson in US Patent Application 2002/0119830 wherein a sub-assembly of plies 22 formed with oriented fibers such as carbon, boron, composite, or metal are shown on a working surface 100. Plies 24 are given the desired shape of a golf club shaft by being rolled onto a mandrel 102, which effectively defines the inner contour of resulting golf club shaft. Additional plies 24 are subsequently positioned and rolled onto the mandrel 102 on top of sub-assembly 22 to form a rolled assembly of plies which is then typically heat-treated to cure and form the golf club shaft. The plies 24 thereby comprising the orientated fibers a matrix within a resin or other material that during the heat treatment will melt to bind each ply 24 to the other plies 24 within the sub-assembly of plies 22.

Mandrel 102 has a tip end and a butt end that corresponds to tip end 18 and butt end 20 of the golf club shaft such that according to the layout of the sub-assembly of plies 22 these are rolled onto the mandrel 102 by rotating in a clockwise or counter-clockwise direction about a longitudinal axis 104 of the golf club shaft. As shown in ply stack 150 the sub-assembly of plies 22 is constructed of first to third plies 24, 26, and 28 respectively, which are shown with their respective tip ends 18 and butt ends 20. First to third plies 24, 26, and 28 are made from pre-impregnated fibers oriented with a bias, referenced transverse to longitudinal axis 104, as shown. For example first ply 24 has an approximate 45-degree bias and second ply 26 has an approximate 135-degree bias and each extends the entire length of the shaft, from tip end 18 to butt end 20. Sandwiched between first and second plies 24 and 26 is third ply 28 which has a 90-degree bias and serves to reinforce butt end 20. Because of the fiber orientation of first to third plies 24, 26, and 28 relative to longitudinal axis 104, these plies are referred to as biased plies.

Positioned on top of biased second ply 26 and aligned with butt end 20 is butt reinforcement third ply 28. The long edge of third ply 28 is offset from a long edge of adjacent second ply 26, typically ranging from approximately ½-1¼ inches. First ply 24 is then placed on top of biased second and third plies 26 and 28 and aligned with both tip end 18 and butt end 20 wherein the long edge of biased first ply 24 is generally not aligned with the long edge of biased second ply 26, the distance separating these edges may for example be 3/16 of an inch and the distance separating the edges of first and second plies 24 and 26 respectively at the butt end 20 is approximately ⅜ of an inch. Construction of golf club shaft typically includes fourth and fifth plies 30 and 32 in addition to sub-assembly 22. Fourth and fifth plies 30 and 32 respectively are substantially shorter in length than biased first and second plies 24 and 26. Oriented with fibers approximately parallel to longitudinal axis 104, the fourth and fifth plies 30 and 32 generally are referred to as longitudinal plies. Longitudinal fourth ply 30 aligns with tip end 18 and longitudinal fifth ply 32 aligns with butt end 20. Longitudinal fourth and fifth plies 30 and 32 respectively may overlap each other according to the exact design of the golf club shaft. Fifth ply 32 typically is offset from plies 24, 26, and 30, which align with an initial position of rotation on mandrel 102, instead fifth ply 32 aligns with a 180-degree position of rotation on mandrel 102.

It would be apparent to one skilled in the art that the angle of the fibers of biased first ply 24 may range from approximately 25 degrees to 65 degrees transverse to longitudinal axis 104, while the angle of the fibers of biased second ply 26 may range from approximately 115 degrees to 155 degrees transverse to longitudinal axis 104. Generally, the fibers of second ply 26 create a supplementary angle to the fiber angle of first ply 24, with respect to longitudinal axis 104. The angle of the fibers of butt reinforcement third ply 28 may range from approximately 80 degrees to 100 degrees transverse to longitudinal axis 104. The angle of the fibers of longitudinal plies 30 and 32 generally range from approximately 10 degrees to −10 degrees transverse to longitudinal axis 104.

Now referring to FIG. 1B there is depicted a method of manufacturing a golf club shaft according to the prior art of Smith et al in U.S. Pat. No. 6,132,323 employing a set of plies of pre-impregnated (pre-preg) carbon fiber sheet 10 and adhesive 12. As shown in exploded assembly 120 pre-preg plies 10a and 10b comprise carbon fiber bound within a thermoplastic resin, and pre-preg ply 10c comprises carbon fiber bound within a thermosetting resin. Those skilled in the art will appreciate that in alternative forms different composite materials, such as glass fiber, might be used, and that the use of such materials would be an equivalent substitution of components. In the embodiments described herein and shown the ply/plies of pre-preg including the thermoset resin is/are preferably oriented at +/−45°, and the ply/plies of pre-preg including the thermoplastic resin is/are oriented at 0°. However, those skilled in the art will appreciate that, depending upon the design characteristics desired for a particular shaft, additional layers of fiber or pre-preg may be utilized, and the orientation of the layers of fiber or pre-preg may be varied.

The pre-preg carbon fiber sheets comprising plies 10a-c may be manufactured by pulling strands of carbon fiber, or a fabric or weave of carbon fiber, through a resin solution and allowing the resin to partially cure. Moreover, when the resin is partially cured, the resin holds the fibers together such that the fibers form a malleable sheet. The steps that may be followed in manufacturing a golf club shaft in accordance with the present invention may proceed, for example, as follows. The dimensions and relative positions of the plies of pre-preg carbon fiber 10 and adhesive 12 are determined, and a set of plies 10a-c and 12 to be used within the shaft are prepared. A mandrel 14 having predefined dimensions is selected and covered by a bladder (not shown). The bladder may be formed, for example, from latex, rubber or silicone. The plies 10a and 10b (i.e. the plies including the thermoplastic resin) are then wrapped around the bladder-covered mandrel 14 in a predetermined manner, and pre-cured. Thereafter, the ply of adhesive 12 may be wrapped over the pre-cured layers of thermoplastic pre-preg, and the ply 10c (or plies, if desired) of thermoset pre-preg may be wrapped over the adhesive 12. After the various plies 10a-c and 12 are wrapped around the mandrel 14 in the prescribed manner, a cellophane or polypropylene tape (or other shrink wrapping material) may be wrapped around the outermost layer of pre-preg, and the wrapped mandrel assembly may be placed in a mold and heated for a time sufficient to allow the plies of pre-preg comprising the golf club shaft to fully cure.

Following this process, the part may be removed from the mold, the shrink-wrapping material may be removed from the part, and the exterior surface of the part may be sanded and finished to specifications of the manufacturer or golfer. Those skilled in the art will appreciate that, depending upon the type of resin used, oven temperatures may range from 250° to 800° F., the requisite curing time may range from a few minutes (for example, in the case of “quick cure” epoxy or thermoplastic resins) to several hours, and the pressure applied via the latex bladder may range from 0 psi (for some thermoplastic resins) to 1,000 psi. Thus, during the pre-curing phase the oven temperature will be set to that applicable to the plies to be pre-cured, and during the final curing stage, the oven will be set to the temperature applicable to the uncured plies.

Alternatively, one or more plies of pre-preg including a thermoset resin may be wrapped around a first mandrel and pre-cured to form a shell structure. Thereafter, the mandrel may be removed, and a plurality of plies of pre-preg including a thermoplastic resin may be wrapped around a second, bladder covered mandrel, a layer of adhesive may be wrapped over the plies of thermoplastic pre-preg, and the plies of thermoplastic pre-preg and adhesive may be inserted into the shell formed by the ply (or plies) of thermoset pre-preg. Finally, the wrapped mandrel and shell assembly may be placed in a mold, the bladder may be inflated to a predetermined pressure, and the mold may be heated to a predetermined temperature and for a time sufficient to allow curing of all of the plies of pre-preg comprising the golf club shaft. As explained above, the ply/plies of pre-preg including the thermoset resin is/are preferably oriented at +/−45°, and the ply/plies of pre-preg including the thermoplastic resin is/are oriented at 0°.

However, those skilled in the art will appreciate that, depending upon the design characteristics desired for a particular shaft, additional layers of fiber or pre-preg may be utilized, and the orientation of the layers of fiber or pre-preg may be varied. Further, it will be appreciated that filament winding processes also may be utilized to produce golf club shafts in accordance with the present invention. In such embodiments, it may be desirable to filament wind strands of nylon with graphite reinforced thermoplastic pre-preg onto a mandrel in a +/−45° orientation, and to pre-cure the resulting structure. Thereafter, a layer of adhesive may be wrapped over the pre-cured fiber layer, and one or more plies of pre-preg staged within a thermoset resin may be wrapped over the adhesive layer. Preferably, the plies of thermoset pre-preg are aligned in a 0° orientation. Finally, the wrapped mandrel assembly may be wrapped with a cellophane or polypropylene tape, placed in a mold, and heated to a predetermined temperature for a time sufficient to allow the various layers of composite to fully cure.

Referring to first shaft 122 a golf club shaft in accordance with the invention described above in respect of exploded assembly 120 is shown comprising a shaft wall structure 20 including a plurality of layers 22 comprising composite fiber fixed within a first thermoplastic resin binding matrix, one or more layers 24 of composite fiber fixed within a second thermoset binding matrix and at least one layer 26 comprising an adhesive, wherein the adhesive upon curing provides a bond between the layers of composite fixed within the thermoplastic and thermoset binding matrices. Further, those skilled in the art will appreciate that, while it is presently preferred that the layer(s) of composite including the thermoset binding matrix encase or surround the layers of composite including the thermoplastic binding matrix, the order of the layers may readily be reversed, as shown in second shaft 124. Additionally, it would also be understood by one of skill in the art that the methods of the present invention may be utilized to form sections of a golf club shaft and that neither the thermoset nor thermoplastic layers of composite need necessarily extend along the entire length of the golf club shaft. Further as will be evident from alternative constructions presented below these layers of composite may be increased to form a substantially thicker or sold end to the golf club shaft where the shaft will engage the hosel of the golf club head or grip.

Now referring to FIG. 1C there is depicted another method of manufacturing a golf club shaft according to the prior art of Jackson in U.S. Pat. No. 5,788,585 with assembly view 130. In this alternate manufacturing method a shaft 10 is formed from a composite material including a plurality of laminar sheet material-type plies that are formed of flexible fibers. Such fibers may include for example boron, tungsten, iron or carbon in the form of graphite. For example, the material may comprise graphite-based, binder-containing, heat-settable fibers formed into a sheet with a predefined, uniform orientation of the fibers in the sheet. Such a sheet optimally may be oriented relative to the long axis of shaft 10 to orient the fibers contained in the sheet to provide the desired structural characteristics for shaft 10. The selective orientation of the fibers in the material in the preferred embodiment is shown in assembly view 130 showing the material in layered sheets or plies, before it is formed into the shaft shape of shaft 10. It will be seen that the plies are grouped into two discrete segments. The plies may be characterized by the orientation or bias of the fibers in the plies, relative to the longitudinal axis of the plies. Those plies in which the fibers are aligned with the longitudinal axis are referred to herein as longitudinally oriented plies, and those plies in which the fibers extend at an angle to the longitudinal axis are referred to as angularly oriented or biased plies.

Generally the plies alternate between angularly biased fibers and longitudinally oriented (unbiased) fibers. For example, in a first segment 30, shown in the lower portion of assembly view 30, the plies include an angularly biased ply 31, an adjacent longitudinally oriented ply 32, another angularly biased ply 33 adjacent ply 32, and finally another longitudinally oriented ply 34. It will be seen that the fibers in angularly biased plies 31 and 33 are shown at mirrored angles to each other. The preferred angle of plies 31 and 33 is approximately 45-degrees to the longitudinal axes of the plies, which also means that the fibers in ply 31 are perpendicular to the fibers in ply 33. A similar fiber arrangement is found in a second segment 35. Thus, the plies include an angularly biased ply 36, a longitudinally oriented ply 37, another angularly biased ply 38, and another longitudinally oriented ply 39. Longitudinally oriented ply 37 is immediately intermediate angularly biased plies 36 and 38. The fibers in angularly biased plies 36 and 38 are mirrored similar to plies 31 and 33, but the angular bias is such that the fibers are oriented at approximately a 60-degree angle to the longitudinal axes of the plies. This means that the fibers in plies 31 and 33 are closer to alignment with the longitudinal axes of the plies than are the fibers in plies 36 and 38. When the plies are formed into a finished shaft, as described below, it will be seen that the longitudinal axes of the plies is axially oriented relative to the shaft.

By dividing all of the plies of the composite material into two discrete segments of substantially continuous fibers, as opposed to continuous fibers running substantially the entire length of shaft 10, the resulting golf club shaft 10 may be perceived by many golfers to be more responsive than a conventional club with improved resistance to flexure and torsion. Segments 30 and 35 are rolled into a finished shaft having a laminar structure shown wherein the thickness of the plies and segments once assembled rather than giving a stepped structure to the shaft in reality smoothly tapers from one segment to the other as the plies are very thin.

An alternate method of manufacturing a golf club shaft according to the prior art of Tennent et al in U.S. Pat. No. 5,265,872 is shown in FIG. 1D. Unlike the shaft of the present invention described above in respect of FIGS. 1A to 1C this golf club shaft has what may be termed a “modified hour glass” shape. The shaft 10 as shown comprises five sections, which as designated from the top or upper (grip) end 12 to the bottom or lower (club head) end 14 of the shaft are respectively the grip section 16, the lower flare section 20, the flex control section 18, the upper flare section 36 and the hosel section 22. While these sections represent slightly different structures physically, it will be understood they are all part of the unitary shaft and that there are no abrupt physical joints between the sections. The sections are designated herein for ease in referring to the different regions of the structure of the present shaft 10, rather than to imply that the shaft 10 itself is formed of separate components that must be joined. It would be evident to one skilled in the art that the number of sections may be increased or decreased according to the complexity of the design, desired performance of the golf club shaft.

The substrate of the shaft 10 is base rod 24, which extends for the length of the shaft 10, which is an elongated rod formed about axial centerline 26. It is, as shown in cross-section 140, hollow throughout its length but if desired (as for weight distribution) either or both the upper and lower portions of the rod 24 may be solid as indicated in section 142. The solid lower portion will start at the lower end 14 but should not extend into the flex control section 18 since such would adversely affect the flex, stiffness and torque of the shaft 10. The base rod 24 of the shaft 10 will typically have a slight taper throughout its length, since the interior hollow space 30 should have such a taper to permit withdrawal from the mandrel on which it is formed. The base rod 24 is formed by wrapping successive layers of fiber-reinforced composites until the desired thickness of wall 32 is obtained. Typically a shaft may have 5-25 layers or plies 34 of composites; 10-20 layers being common. As shown in schematic detail 144, each successive ply 34 (here designated 34a, 34b and 34c) will normally be laid up in manufacturing so that the orientation of the fiber reinforcement in one layer or ply 34 is at a marked angle to the orientation of the fibers in each of the immediately adjacent layers 34. Typically the angular difference is 30°-90°, although other angular differences may be used. It is also desirable in some cases for successive layers to have parallel orientation, such as the outer layers of the shaft.

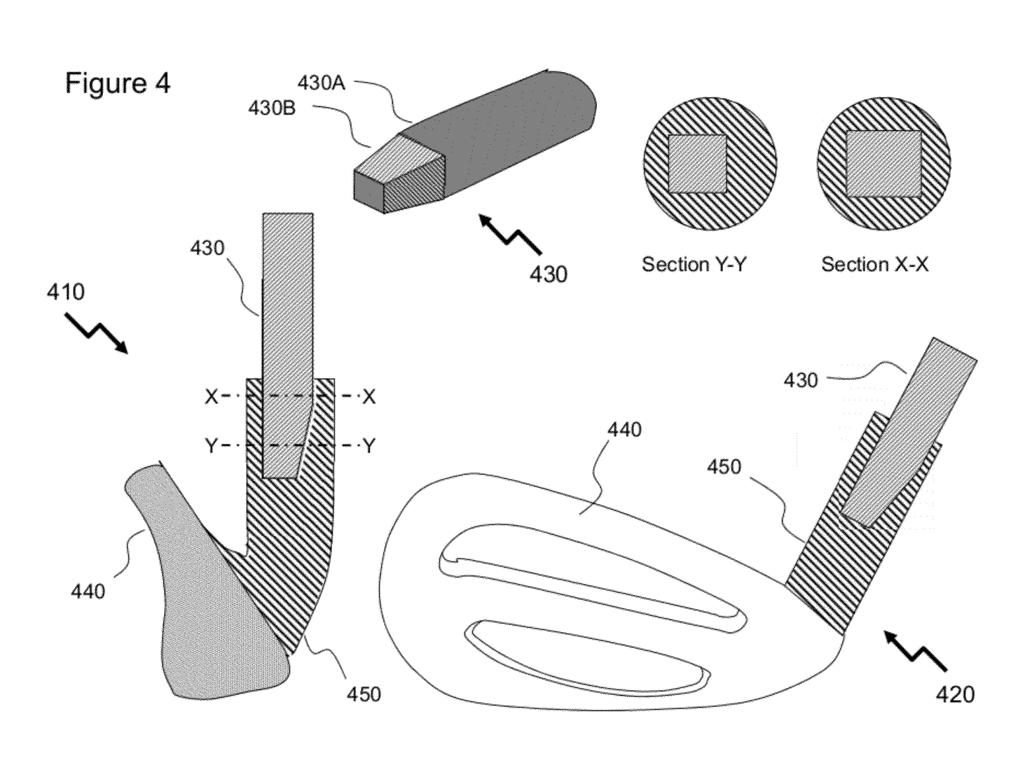

The average outside diameter of the base rod 24 will be on the order of about 0.375″ (1 cm) near the middle of the shaft 10, with a wall 32 thickness of about 0.1″ (2.5 mm). It will be recognized that the axial taper of the base rod 24 will result in a slightly greater outside diameter at the upper end 12 and a slightly lesser diameter at the lower end 14, although wall 32 thickness will generally be constant throughout. Average diameter and/or wall thickness may be varied if desired for a thicker or thinner shaft. As shown in cross-section 140 the base rod 24 itself principally makes up flex control section 18. Few additional over-wrapping layers are applied to the base rod 24 in this section, and then usually only near the upper end (although there will normally be surface coatings as described below). All of the other sections are then formed by applying over-wrapped layers or plies 34 to the outer surface of base rod 24 so that they will have greater average diameters than that of flex control section 18. Above the flex control section 18 is the grip section 16, which extends to and abuts the upper flare section 36 and continues to the top end 12 of the shaft as either a constant diameter or may have a tapered outer surface parallel to the outer surface of the base rod 24. This permits a club grip to be fitted over the grip section 16 and adhered thereto, as shown in FIG. 4B below. The maximum diameter of grip section 16 is limited by the maximum outer diameter of the grip which must have a diameter large enough, but not too large, to enable a player to comfortably hold and swing the club in the normal manner. Commonly the maximum outer diameter of the grip section 16 will be on the order of about 0.1″ to 0.2″ (2.5-5.0 mm) greater than the average outer diameter of the base rod 24. Most players' hands are of similar sizes, and the standard outer sizes of golf club grips are well known and need not be detailed here.

Now referring to FIG. 1E there are shown aspects of manufacturing a golf club shaft according to the prior art of Blough, Renard and Watanabe in U.S. Pat. Nos. 6,845,552; 6,139,444; and 5,397,636 respectively. Referring first to pre- and post-molding schematics 150 and 155 respectively then in pre-molding schematic 150 there is shown a tube 10A depicted that is step formed to be formed into shaft 10B. The step pattern is formed onto tube 10A by holding the grip end of the shaft rigidly, and pushing the opposite end of the tube, which will become the tip section of the s shaft, axially through one of more cylindrical dies, the inside diameter of which are less than the grip end diameter. The tube is pushed sufficiently far through each die such that the shaft obtains the appropriate diameter of each point along its length. Desirably, the grip end outside diameter is equal to, or slightly smaller than the inside diameter at or near the corresponding grip end of the hydroform mold, and the tip end outside diameter of the shaft is equal to or slightly smaller than the inside diameter at or near the tip end of the hydroform mold. That is, the shaft, before hydroforming, has section(s) with outer diameter(s) or dimensions which are generally at least about 50% desirably about 60%, 75%, or 85%, and preferably at least about 87% or 90% of the corresponding inner diameter dimensions of the female hydroform mold.

The shaft is subsequently hydroformed in a hydroforming apparatus as described in U.S. Pat. No. 6,014,879 entitled “High Pressure Hydroforming Press” by Jaekel et al. The process entails placing the tube 10A into one half of the female hydroform mold. The halves of the hydroform mold 122, 124 comprise a mold cavity 128 of one of more machined sections, which are individually contoured to produce a desired shaft. Generally one of the mold halves is mounted on a moveable slide that allows the mold to be moved for shaft loading and unloading. The apparatus contains a mold portion that is carried by a platen driven up and down vertically by hydraulic cylinders. After a tube is placed on the slidable mold section, the assembly is moved horizontally into position under the opposite mold section. The platen carrying the mold section is then hydraulically driven down into contact with the lower mold section by low-pressure hydroforming fluid.

Once the upper and lower mold sections are in position, the tube-end engaging structures 126, or high-pressure end closures seal opposite ends of the shaft in the assembled hydroform mold. Hydroforming fluid, such as but not limited to water, or a water mixture, is first introduced into the tube blank by a low-pressure centrifugal pump. Once the tube blank and platen hydraulic cylinders have reached the equilibrium pressure of the low pressure pump, typically 70-90 psi, they are further pressurized by an air over hydraulic intensifier pump (or pumps) to further pressurize the interior of the tube blank. As the internal pressure in the tube exceeds the materials yield strength, generally pressure great enough to exceed the yield strength of the material being formed or from about 10,000 psi to about 50,000 psi, although typically between 15,000 psi and 20,000 psi, the tube blank expands. Expansion continues until the blank material contacts and substantially conforms to the shape of the inner surface of the hydroform mold wherein it becomes the shaft 10B.

The tube is pressurized to a preset pressure or for a preset length of time, which depends at least in part to the material utilized. Once these parameters are met, the pressure is removed from inside the tube, and from the hydraulic platen cylinder. The tube-end engaging structures are disengaged from the mold, and the mold platen is raised. The slidable mold section is then moved to the unload position and the expanded shaft removed from the mold cavity. After the shaft has been hydroformed it can be cut to a desired length for the club being formed. Furthermore, additional processing steps to impart necessary strength and cosmetic appearance to the shaft such as but not limited to heat treating, polishing, and plating, can be performed depending on the metal or metal matrix composite utilized as known to those skilled in the art.

Importantly, the hydroform mold can be designed with a variety of configurations to produce a golf club shaft that alternatively can enhance club feel, performance, or aesthetic design. The hydroforming process is capable of producing current industry standard constant taper and step shafts, but also allows for non-progressive or variable inner and/or outer diameter changes other than a step change throughout the length of the shaft. That is, at least one portion of the inner diameter can have any number of shapes such as sinusoidal, curvilinear, concave, convex, etc., linear tapered inward or outward, and the like. While generally not varied as often, at least one portion of the outer diameter can have any number of the shapes just noted. Moreover, the wall thickness of the shaft can vary in at least one portion from thinner to thicker, from thicker to thinner, and the like. Shafts thus can be created which include features or ornamental designs, such as but not limited to hour glass shapes, bubble shapes, multiple protrusions, indentations, flutes, grooves, and/or ridges that can be added at any point along the shaft. Performance enhancing grooves and ridges can be oriented at any angle on the shaft from annular rings to bias lines, to parallel lines. Geometric or arbitrary patterns, logos, trademarks, symbols, quality markings, manufacturing names, etc., can also be formed on or in the shaft during the molding process.

Referring to alternate shaft 10C, which utilizes a tubular metallic sheath 14 comprising a grid or cloth. The sheath 14 may comprise metallic wires arranged at an angle with respect to the longitudinal axis of the shaft 10C. The sheath 14′ may utilize nonmetallic wires or fibers in a meshed relationship with metallic wires. Depending upon the number and orientation of the metallic wires, the shaft 10C can have mechanical characteristics similar to that of the shaft 10 utilizing the resulting metal tube 14 that is formed during the hydrostatic molding process.

Now referring to FIG. 1F there is depicted a method of manufacturing a golf club shaft according to the prior art of Swinford in U.S. Pat. No. 5,873,793. A partly sectional, perspective view of the transitional region of a streamlined shaft 16 is depicted in perspective section 180. The skin 28 is partially removed from the shaft 16 exposing the spar 26, core 32, tube 30, filler material 34, and a thin film 36. The portion of the core 32 opposite the trailing edge 31 (the leading edge portion) of the streamlined shaft 16 is not shown in order to illustrate the transitional shape of the spar 26. The filler material 34 is partially removed in order to illustrate the void created by the tapered annular surface 33 of the spar 26 and the end of the tube 30. The thin film 36, described in greater detail later, is partially removed from the spar 26 and core 32 for clarity.

A golf club shaft according to the design approach shown in perspective section 180 may use a blend of high and low modulus composite materials and metallic materials. It is necessary to have a high value for the longitudinal Young's modulus of the spar 26 in order for it to restore bending properties about the X axis of the shaft 16, one such material being a uni-axial filament aligned graphite/epoxy composite wherein the filaments are aligned in the Z direction of the shaft 16. Such composites can exhibit extremely high modulus of 200 Gpa and above. A method of manufacture of the spar 26 is to press uni-axially orientated filaments and resin binder into near net shape, using dies under high pressure. This part is then cured, removed from the dies, and machined to length wherein the recessed surfaces 23 of the spar 26 be formed to net shape. Excess material would be orientated in the areas that will later be machined away, forming the surfaces of the spar 26 contacting the skin 28. Due to the faceted nature of the streamlined region of the shaft 16, complex machining of the surfaces of the spar 26 is minimized.

An alternate method of manufacturing the spar 26 is to machine from solid composite bar stock that may be less desirable due to the anticipated operation time. If it is impractical to manufacture the spar 26 by the above methods, the spar 26 may be made from an alternate homogeneous material. Alternate materials for the spar 26 include titanium or steel, with Young's modulus equal to approximately 100 GPa and 200 GPa respectively. Both would offer lower modulus and increased weight over some graphite composites, however, forming the spar 26 from these materials may offer an advantage over composites in terms of cost, complexity of cross-section, or transitions in cross-section design for example between the main shaft length and the short sections that engage the golf club head hosel and grip. The spar 26 if constructed from these materials could be forged, cast, or powder sintered to near net shape, requiring little or no post-machining. The density of these alternate materials may limit the practical length of the streamlined section of the shaft 16 wherein a maximum weight limit is encountered.

The tube 30 may be constructed with a filament winding process such as described above in respect of FIGS. 1A through 1D, whereby fibers pre-impregnated with a resin binder are wrapped around a temporary mandrel at a predetermined angle. The material for the tube 30 would preferably be a high modulus composite, such as the graphite/epoxy candidates previously described. In lieu of a composite material, the tube 30 could be constructed from drawn metallic tubing, such as steel or titanium. At the expense of increased weight, the use of a metallic tube 30 could offer the advantage of reduced manufacturing time by eliminating the necessity for a temporary mandrel, since the tube 30 would not be filament wound. Additionally, it may be easier to join the tube 30 to the spar 26 by brazing, welding, swaging, or fastening.

Whilst tube 30 is depicted as circular it would be evident to one skilled in the art that the tube 30 may be square, polygonal, or other alternate configurations. The skin 28 may also be constructed in a conventional filament winding process, however, as opposed to the tube 30 which may use a temporary mandrel during filament winding, the skin 28 could be constructed by wrapping a fibrous resin impregnated material at a predetermined angle directly over the spar 26, tube 30, core 32, filler material 34, and thin film 36. The material for the skin 28 would preferably be a lower modulus composite, such as S-glass/epoxy, in order to minimize its contribution to shaft stiffness about the Y-axis in the fully streamlined region. It may not be necessary to filament wind material forming the skin 28 along the entire length of the shaft 16. However, filamentary material forming the skin 28 could at least be wrapped from the tip of the shaft 16 to a distance along the shaft 16 at which the spar 26 is cylindrical in cross-section, in order to create the previously mentioned structural joint. The skin 28 has a nearly constant wall thickness for simplicity, however, the wrap angle of the filaments forming the skin 28 may vary from the cylindrical portion to the streamlined portion of the shaft 16.

An alternate method of manufacturing the skin 28 would be to injection mold two plastic halves that are mirrored copies of each other. These halves would then be bonded to the spar 26 and core 32 using a structural adhesive. The material utilized for the core 32 for weight considerations could be foam, such as polystyrene or Styrofoam™. The foam would ideally be molded around the spar 26 in order to minimize final shaping. An alternate material that could be employed is balsa wood. The disadvantage with using this material would be the increased work required to shape the core 32. The core in the vicinity of the streamlined skin using these materials would have a low density, for example 2.0 kg/dm³.

During filament winding of the skin 28, a high level of pressure may be exerted on the relatively sharp trailing edge 31 of the streamlined region of the shaft 16. This might cause the filament tow to dig into the core 32 instead of laying on the surface. Therefore, it may be necessary to apply the previously mentioned thin film 36 over the exterior of the streamlined portion of the shaft 16 prior to filament winding of the skin 28, thereby increasing the bearing strength of the core 32. This film 36 may take the form of a spray or dipped epoxy-like coating, a heat-shrunk plastic such Mylar™. If the previously mentioned films do not provide adequate core 32 bearing strength for filament winding, a temporary core 32 may be affixed to the spar 26. This temporary core 32 could be in the form of a hard wax for example. Once filament winding of the skin 28 is complete, the temporary core 32 could be removed by raising its melting temperature during the curing of the skin 28, or subsequent to this step. A permanent foam core 32 could then be injected into the cavities of the shaft 16, or if the skin 28 possesses sufficient transverse compressive strength, omitted entirely.

First cross-section 182 is a cross-sectional view of a shaft 16 manufactured according to this embodiment of the invention wherein the shaft 16 has a spar 26, a skin 28, and a tube 30, each having circular cross-sections. The tube 30 ending at a position wherein the structure changes to one with the non-circular geometry and in this region the spar 26 and skin 28 are separated from on another by the interior and exterior surfaces of the tube 30. Additionally, the interior portion of the spar 26 defines a cavity 27 with a circular cross-section. In second cross-section 184 there is a cross-sectional view of the shaft 16 taken along a cutting plane that represents the shaft 16 as it has midway transitioned from a circular shape to a non-circular, in this case streamlined shape. The shaft 16 embodies a leading edge 29 and a trailing edge 31. In this vicinity, the skin 28 is in direct contact with a portion of the spar 26 and a core 32. The core 32 provides shape during filament winding of the skin 28. The core 32 is divided into two parts within the interior of the skin 28, a first portion in the region of the leading edge 29 of the shaft 16, and a second portion in the region of the trailing edge 31. Division of the two portions of the core 32 is due to the web of the spar 26. The spar 26 depicted in second cross-section 184 is midway transitioned from a circular cross-sectional shape to an I-beam like shape. The spar 26 may have a recessed surface 23 generally mirrored about the Y-axis of the cross-section, forming a web 25. In this vicinity, the spar 26 introduces a slightly greater moment of inertia about the X-axis than about the Y-axis, due to the recessed surfaces 23. This is necessary to counteract the skin 28 that has slightly greater moment of inertia properties about the Y-axis than about the X-axis.

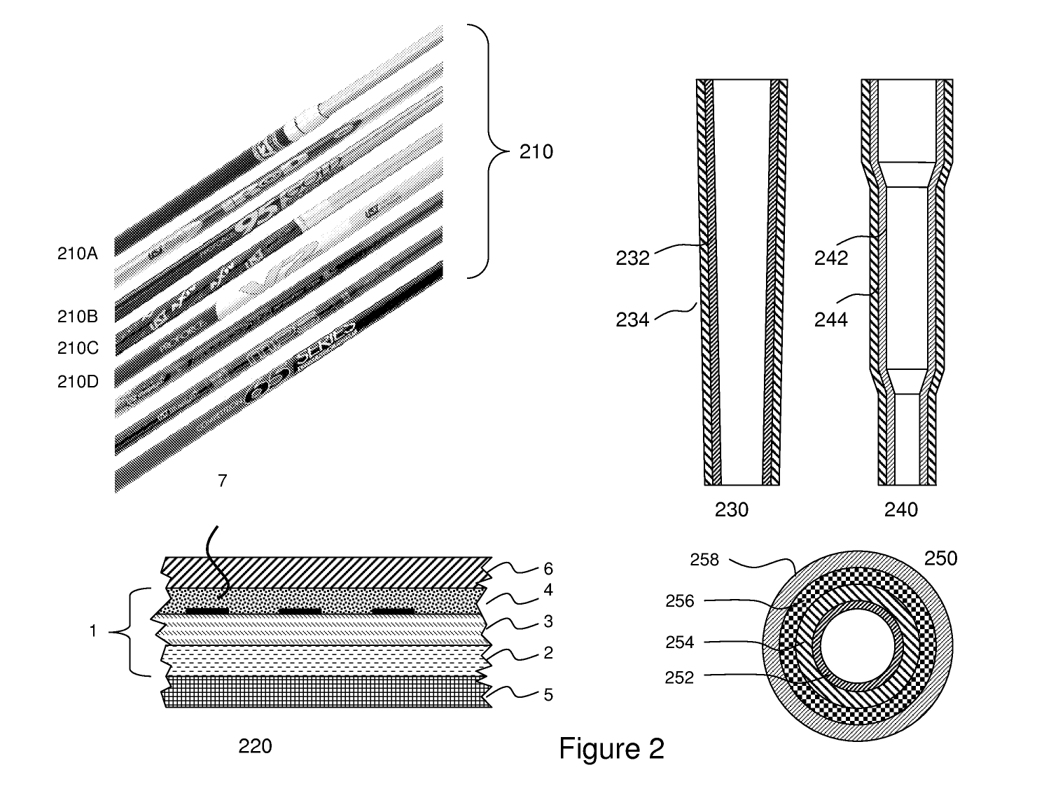

Now referring to third cross-section 186 taken along cutting plane of the shaft 26 representing that of an approximated airfoil composed of many facet-like edges, representing the cross-section in the non-circular region. It would be evident to one skilled in the art that this non-circular region may be of many designs such as described below in respect of embodiments of the invention in FIGS. 2 through 10. For example fourth cross-section 188 depicts an alternate embodiment of the present invention. In this embodiment the shaft's cross-sectional shape is an approximated airfoil with exactly six (6) facet-like edges, forming a diamond-like shape. In each of third and fourth cross-sections 186 and 188 respectively the shaft 16 has a cross-section that has fully transitioned to a shape that provides a single orientation for inserting the shaft to a corresponding recess on a golf club hosel or grip. The facet-like shapes offer reduced machining complexity of the core 32 and spar 26 prior to filament winding of the skin 28.

Referring to FIG. 2 there are depicted typical golf club shafts 210 of graphite from one manufacturer UST Mamiya wherein 8 different shafts are presented. These include first to fourth shafts 210A through 210D that are targeted to putters, irons, women, and woods respectively. It can be seen that these golf club shafts 210 have graphics that can include manufacturer's trademarks, product branding, as well as cosmetic effects. Within the preceding embodiments hybrid laminated pre-preg layers have been employed in forming a golf-club shaft either completely or partially such as skin 28 in FIG. 1F. It would be evident to one skilled in the art that such pre-preg layers can provide the mechanism for providing these graphical elements of the finished golf club shaft. As shown in laminate cross-section 220 according to an embodiment of the invention after Watanabe in U.S. Pat. No. 5,397,636 that comprises a resin layer 2, a decorative layer 3 laminated thereon, and a transparent fiber reinforced composite resin layer, i.e., transparent pre-preg layer 4, laminated on the decorative layer 3. This hybrid laminated pre-preg 1 is used in combination with the pre-preg layers discussed supra to produce a fiber reinforced composite resin material molding such that it is laminated as the outermost layer of a lamination of pre-preg layers wound for lamination on a mandrel or the like, the decorative layer 3 thus providing an aesthetic sense of appearance to the molding obtained by hardening the overall pre-pregs. The whole hybrid laminated pre-preg 1 is supported on a releasing paper 5, on which the innermost resin layer 2 is laminated. A transparent cover film 6 is laminated on the outer transparent pre-preg layer 4, if desired. The releasing paper 5 and a cover film 6 are removed when the hybrid laminated pre-preg 1 is used.

The resin layer 2 provides for adhesion of the hybrid pre-preg 1 to the outermost layer of the usual pre-preg lamination, on which the pre-preg 1 is laminated. As the resin layer 2 may be used thermosetting epoxy resins or like usual matrix resins used for usual pre-pregs. The resin layer 2 is usually transparent but may not be transparent. The weight of the resin layer 2 on the releasing paper 5 is typically between 5 to 200 g/m2. The decorative layer 3 serves to impart the molding with an aesthetic sense of appearance, and it has a pattern 7. The decorative layer 3 comprises a base on which the pattern 7 is formed. The pattern 7 is provided on the side of the decorative layer 3 opposite the resin layer 2 and hence can comprise pictures, patterns, trademarks and alike or it may be mere coloring of the surface of the decorative layer 3 and may be partial or entire coloring of the surface of the decorative layer 3. Further, the pattern 7 may be formed in a single color or a plurality of different colors.

As the decorative layer 3 with the pattern 7 may be used a paper or resin sheet with the pattern 7 provided by a printing or electrophotographic process. Such a paper sheet as the base with the pattern 7 provided thereon is suitably capable of being uniformly impregnated with resin from the resin layer 2 to provide enhanced integrity with the resin layer 2. Likewise, the resin sheet noted above suitably has high affinity to the resin in the resin layer 2. If the base is resin-permeable, it is possible for air bubbles present in the resin layer 2 to pass through the base to the pre-preg layer 4 and thus it is possible to obtain an effect of purging air bubbles through the pre-preg layer 4 to the outside.

The paper or resin sheet as the base of the decorative layer 3 is further suitably capable of becoming transparent when permeated by resin from the resin layer 2. In this case, the pattern 7 of the decorative layer 3 looks like floating with the transparent base as background, and thus it is possible to provide more excellent aesthetic sense to the appearance of the molding. Examples of such base are thin paper sheets or non-woven cloths of thermoplastic resins such as nylon and PET having thicknesses of between approximately 10 μm and 100 μm. The ink used for the pattern 7 is selected to suitably free from deterioration and fading by heat provided when hardening the pre-preg to obtain a molding.

If it is desired to conceal the color of the usual pre-preg materials with the hybrid pre-preg 1 laminated thereon even with sacrifice in the transparency due to providing permeability within the resin in the base of the decorative layer 3, then a base may be used such as a paper sheet containing TiO2 or like pigment having a concealing ability with respect to the color of the ground or a sheet of an opaque resin. The thickness of the decorative layer 3 is generally between 5 μm and 500 μm, and more typically between 10 μm and 300 μm. It would also be evident that the pre-preg layer 4 has a role of protecting the inner decorative layer 3 since it is transparent to let the pattern 7 of the decorative layer 3 be seen from the outer side of the pre-preg layer 4. As such pre-preg layer 4 may be implemented using a transparent pre-preg comprising transparent reinforcement fibers and a matrix resin.

Examples of such transparent fibers include but are not limited to glass fibers, alumina fibers and quartz fibers. These transparent fibers may be used alone, or a plurality of different transparent fibers may be used in hybrid combination and may further be used in the form of uni-directional arrangement or in the forms of cloth or mat. In the case of the use of transparent fibers in the form of cloth or mat, it is possible to use a plurality of pieces of cloth or mat by laminating these pieces such that fibers overlap in the same direction or by laminating these pieces in hybrid combination such that the fibers overlap in an inclined fashion.

As a general rule, common thermosetting resins such as epoxy resins may be used as the matrix resin although from the standpoint of providing the transparency of the pre-preg layer 4, however, resins lacking transparency are not used. The thickness of the transparent pre-preg layer 4 is generally between 10 μm to 200 μm, and typically between 50 μm and 100 μm. The amount of the transparent fibers in the transparent pre-preg layer 4 per unit area thereof is typically between 30 g/m2 and 200 g/m2 with the amount of the matrix resin in the pre-preg layer 4 is generally between 20% to 80% by weight, more typically between 30% to 75% by weight.

The total thickness of the hybrid-laminated pre-preg 1 is generally between 50 μm and 500 μm. If the thickness of the hybrid pre-preg 1 is less than 50 μm then generally it is too thin and makes it difficult to produce the pre-preg 1. In addition, such thin pre-preg layers are generally impractical for producing fiber reinforced composite resin material moldings. Similarly if the thickness exceeds 500 μm then it is generally difficult to produce fiber reinforced composite resin material moldings with satisfactory moldability. The hybrid-laminated pre-preg 1 may be manufactured with many different process flows. One such process flow being that a resin-coated paper is stacked a paper or like sheet with printed pattern 7 such that the pattern 7 is on the side opposite the resin layer, and a transparent pre-preg is then stacked on the paper or like sheet. This stack is then pressed with a thermal press from the outside of the support of the transparent pre-preg and the resin-coated paper, thus integrating the resin of the resin-coated sheet, the paper or like sheet with the pattern 7 and the transparent pre-preg.

Alternatively, in case of manufacturing the transparent pre-preg by pressing transparent fibers stacked on the resin-coated paper with a thermal press, transparent fibers are arranged on the paper or like sheet with the pattern 7 stacked on an another resin-coated paper, the above resin-coated paper for the transparent pre-preg is then stacked on the arranged fibers, and the stack is pressed from the outer side of the outer and inner resin-coated papers with a thermal press. In this way, it is possible to manufacture the hybrid laminated pre-preg by forming the transparent pre-preg from the resin of the outer resin-coated paper and the transparent fibers while also integrating the transparent pre-preg, the paper or like sheet with the printed pattern 7 and the resin of the lower resin-coated paper.

In the manufacture of fiber reinforced composite resin material moldings, the hybrid pre-preg 1 is usually used in combination with other pre-pregs such as carbon fiber pre-preg for example. For example, in a golf club shaft, which basically comprises an inner layer consisting of angle or straight layers and an outer layer consisting of straight or angle layers, the outer layer being combined with and of the opposite kind to layers of the inner layer, a couple of layers of the hybrid laminated pre-preg 1 are used with the resin layer 2 on the inner side as the outermost layer of the outer layer consisting of the angle or straight layers.

As an example, in the case of a golf club shaft, the outermost layer of which is a straight layer, usual pre-preg such as carbon fiber pre-preg is wound on a mandrel a predetermined number of turns for the angle layer with the direction of the fiber arrangement inclined with respect to the axis of the mandrel and a predetermined number of turns for the straight layer with the direction of the fiber arrangement made parallel to the mandrel axis, and when winding the straight layer the hybrid pre-preg 1 is wound a couple of turns as the outermost layer. Then, a retainer tape is wound to prevent deformation of the usual pre-preg and the hybrid laminated pre-preg 1, and in this state the matrix resin is hardened by a heat treatment. In this way, the fiber-reinforced composite resin layers of the usual pre-preg and hybrid laminated pre-preg 1 are rendered into fiber reinforced composite resin material layers, thus obtaining a hardened body having a shape of a golf shaft. Subsequently, the hardened body surface may be polished to obtain a finished golf club shaft.

A golf club shaft manufactured in this way using the hybrid laminated pre-preg 1 as in this embodiment is light in weight and has satisfactory mechanical strength. In addition, the pattern 7 of the decorative layer 3 of the hybrid laminated pre-preg 1 laminated in a single layer to a plurality of layers as the outermost layer, can be seen through the thin transparent layer of fiber reinforced composite resin material constituted by the transparent pre-preg layer 4 at the surface. In other words, the pattern 7 can be seen at the bottom of the thin transparent layer.

Further, in case when the base of the decorative layer 3 such as a thin paper or like sheet is capable of being made transparent by resin permeation, the pattern 7 of the decorative layer 3 is seen floating with the transparent base on the background, thus adding an excellent aesthetic sense to the appearance of the golf club shaft. Further, by providing the ground layer 7a of resin permeation prevention ink under the pattern 7, it is possible to eliminate adverse effects of the resin permeating the decorative layer 3 and further increase the stability of the pattern 7. Further, the decorative layer 3 is protected very firmly by the fiber reinforced composite resin material layers of the transparent pre-preg layer 4.

Referring to first cross-section 230 and second cross-section 240 these are shown each comprising four layers after the prior art of J. Meyer in U.S. Pat. No. 6,805,642 entitled “Hybrid Golf Club Shaft. First cross-section 230 comprises uniform tubular cover layer 232 and tubular core layer 234 whilst second cross-section 240 comprising shaped tubular cover layer 232 and shaped tubular core layer 244. Meyer teaches that the uniform tubular cover layer 232 and shaped tubular core layer 242 are continuous layers formed from at least one isotropic material having a Young's modulus greater than about 5 Mpsi, preferably greater than about 10 Mpsi.

The isotropic material may be a metallic material such as metal matrix composites, metals, or alloys thereof including one or more combinations of metallic constituents. Among the numerous metals that are suitable are ferrous metals such as titanium, steel, stainless steel, aluminum and tungsten are particularly useful. Additionally, certain nonferrous metals including nickel, copper, zinc, brass, bronze, magnesium, tin, gold and silver may be employed generally as alloying agents. Metal matrix composites that are quasi-isotropic may also be desirable for use. The uniform tubular core layer 234 and shaped tubular core layer 244 are taught as being formed from a non-isotropic (i.e. either anisotropic or quasi-isotropic) materials that may be in the form of particles, flakes, whiskers, continuous or discontinuous fibers, filaments, ribbons, sheets, and the like or mixtures thereof. Suitable reinforcement material include carbon fibers, graphite fibers, glass fibers, quartz fibers, boron fibers, ceramic fibers or whiskers such as alumina and silica, metal-coated fibers, ceramic-coated fibers, diamond-coated fibers, carbon nanotubes, aramid fibers such as Kevlar®, poly-phenylenebenzobisoxazole (“PEO”) fibers such as Zylon®, metal fibers, polythenes, polyacrylates, liquid crystalline polymers, and aromatic polyesters such as Vectran®.

These fibers may be coated with a metal such as titanium, nickel, copper, cobalt, gold, silver, lead, etc. The reinforcement material is impregnated within thermosetting or thermoplastic resins, serving as the matrix binder and providing vibration-damping effect to the shaft. Suitable resins include epoxy; polyester; polystyrene; polyurethane; polyurea; polycarbonate; polyamide; polyimide; polyethylene; polypropylene; polyvinyl halide; nylon, liquid crystal polymer, and the like or mixtures thereof. Additionally these resins may further include modifying agents such as hardeners, catalysts, fillers, crosslinkers, etc. Meyer only teaches to shafts that are circular in keeping with the dominant commercial products and majority of the prior art. However, as Applicant there is no limitation to the cross-section when the isotropic material, forming the uniform tubular cover layer 232 and shaped tubular core layer 242, and non-isotropic material, forming the uniform tubular core layer 234 and shaped tubular core layer 244, could be cast, moulded etc with ease to other geometries.

Referring to cross-section 250 an alternate design according to Meyer is shown wherein a reinforcing layer 252, formed from an isotropic or quasi-isotropic material is disposed on the inner surface of core layer 254. This configuration in combination with intermediate layer 256 and outer layer 258 form classic strained layer vibration damping systems that effectively dissipate the mechanical energy in the shaft resulting from striking the golf ball. The reinforcing layer 252 may be continuous or discontinuous, porous or nonporous, similar in construction and/or material composition to cover layer 258 or intermediate layer 256. Alternatively, reinforcing layer 252 may be one or more discrete elements placed at predetermined locations on the shaft to achieve specific objectives, such as weight adjustment, structural reinforcement, stiffness modification, or kick point adjustment, among others.

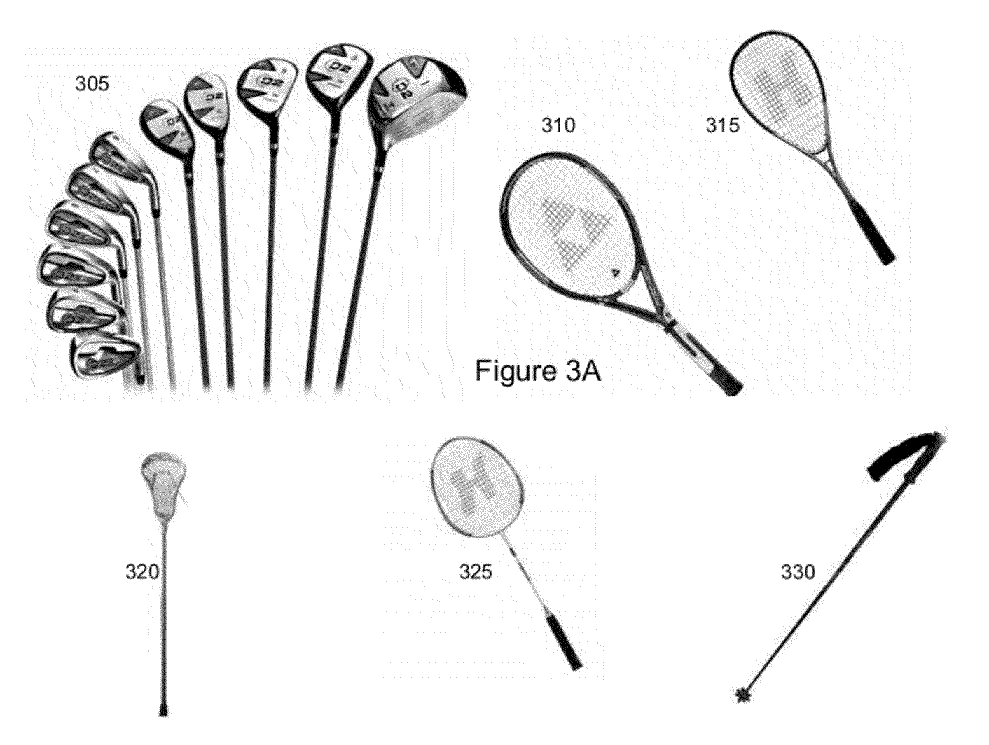

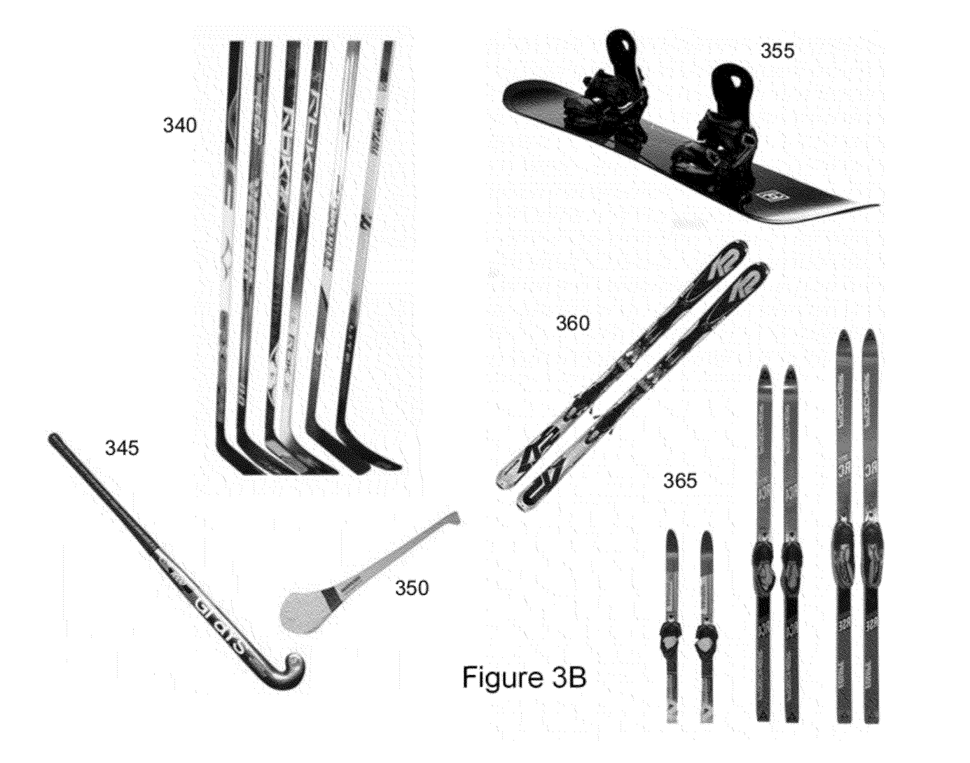

Referring to FIG. 3A there are shown items of sports equipment that typically employ a circular shaft. These include golf clubs 305, tennis racket 310, squash racket 315, lacrosse stick 320, badminton racket 325, and ski pole 330. In contrast, referring to FIG. 3B there are depicted items of sports equipment that typically employ non-circular elements within them. These include ice hockey sticks 340, field hockey stick 345, hurling stick 350, snowboard 355, cross-country skis 360 and downhill skis 365.

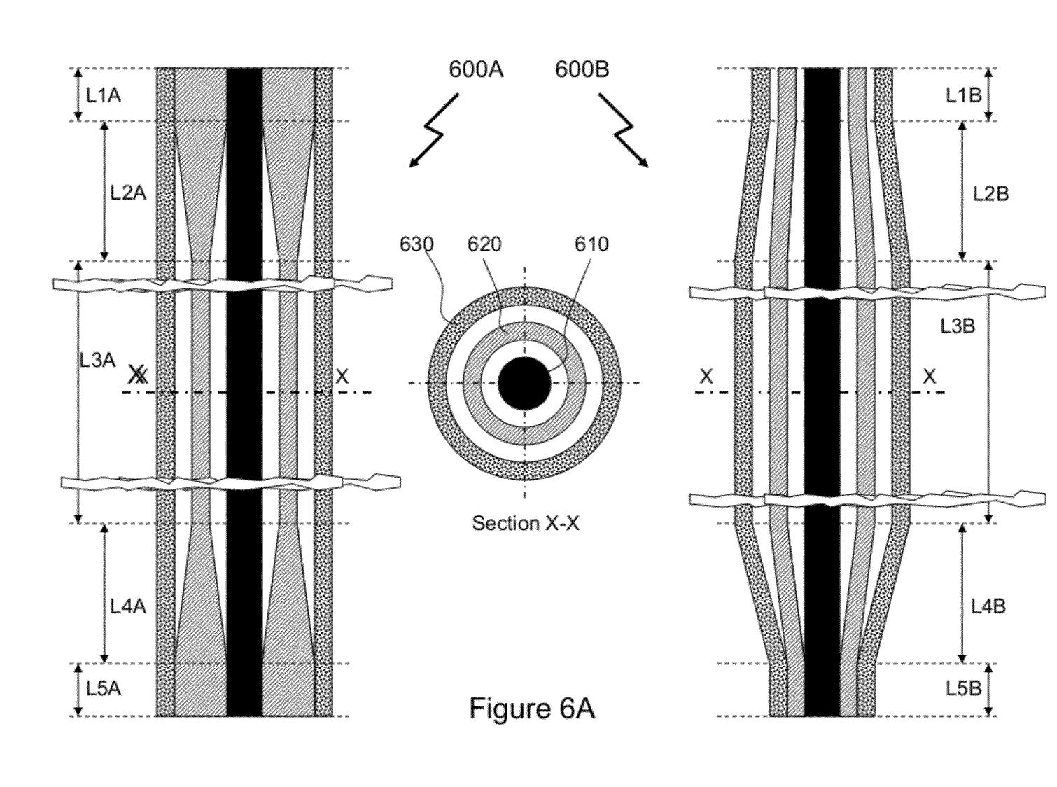

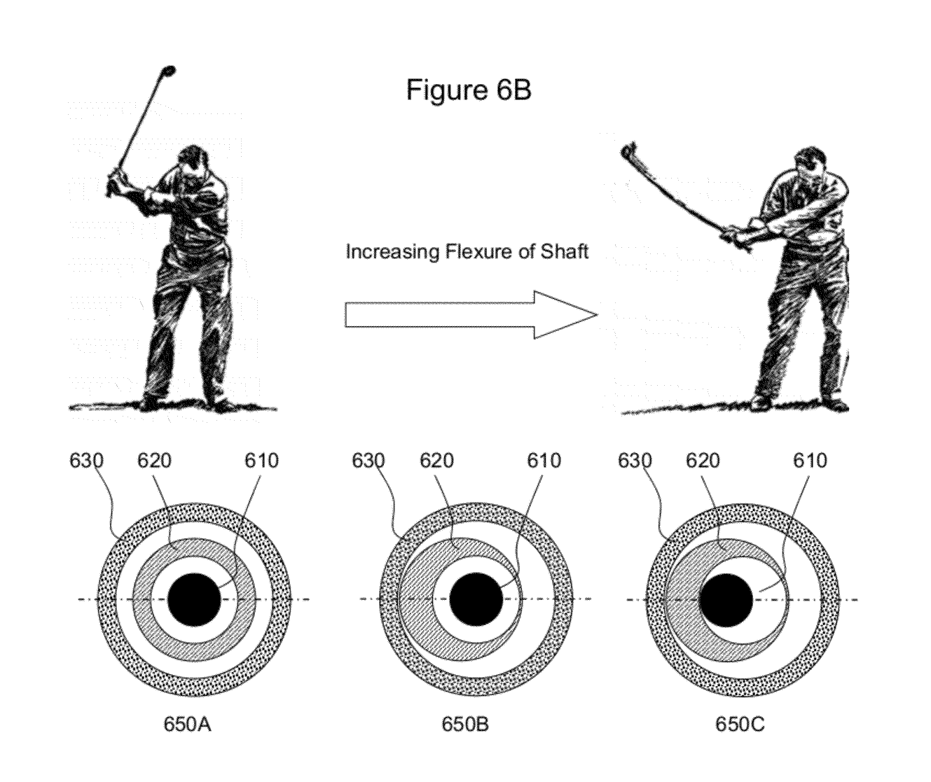

Now referring to FIG. 4 there is depicted a golf club assembly in side section view 410 and front section view 420 according to an embodiment of the invention wherein a golf club hosel 450 and shaft 430 are aligned through their mating interfaces, and the golf club hosel 450 is connected to the clubface 440. As is evident the shaft 430 is comprised a body 430A of circular geometry 430A and taper 430B of variable quadrilateral cross-section. As shown the taper 430B fits within the golf club hosel 450 which having a corresponding recess of variable quadrilateral cross-section will receive the taper 430B in only one orientation. Also shown are first and second cross-sections X-X and Y-Y through the side section view 410 showing the engagement of the taper 430B and golf club hosel 450. Accordingly, as will be evident from the descriptions below in respect of FIGS. 6 through 12 the characteristics of the shaft or portions of the body of the item of sports equipment may be varied either in uniform manner or non-uniform manner such that particular axes of the shaft or body exhibit different properties to others. In these situations it would be beneficial for the other elements of the item of sports equipment to be aligned accurately to the shaft or body. Additional embodiments of aligned interfaces may be found in U.S. Patent Applications 61/420,819 “Golf Club Hosel” and 61/421,665 “Golf Club Shaft” by the inventor.

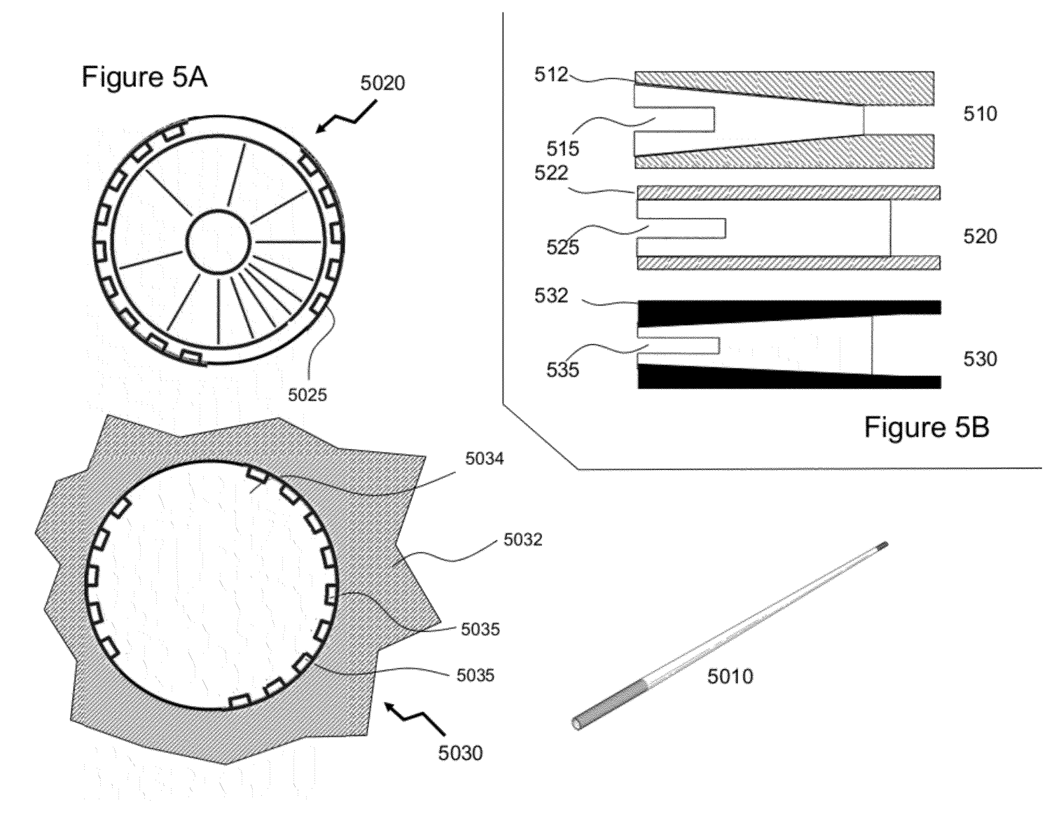

In the embodiments described within these patent applications supra the recess/member have been discussed as being of relatively simple cross sectional design. It would be apparent to one of skill in the art that alternative designs exist that have increased complexity such as the interface shown in FIG. 5A wherein a shaft 5010 is depicted with grip engagement 5030 and hosel engagement 5020. As evident from the end-elevation view of hosel engagement 5020 the shaft has a circular tapering geometry and a series of grooves, being 5 on the right hand side (RHS) and 9 on the left hand side (LHS). Hosel portion 5030 comprises a hosel body 5032 within which a hosel recess 5034 has been formed which has a series of splines 5035, being 9 on the RHS and 5 on the RHS. Accordingly the hosel engagement 5020 can only engage the hosel recess 5034 within the hosel body 5032 in a single orientation such that the shaft 5050 is aligned in predetermined manner to the hosel body 5032 and the golf club of which it forms part, not shown for clarity. It would be evident that a similar construction may be provided for the grip engagement 5030 and the inner surface of the grip recess, not shown for clarity such that by the relative locations of the splines and recesses at either end the grip and hosel, and therein golf club head, are aligned in a predetermined manner.

It would be evident to one skilled in the art that the methods of manufacturing described above can support integration of such recesses directly or by incorporating an additional element into the design to which the golf club shafts described above in respect of FIGS. 4A through 11 are integrated during the manufacturing process. One such example being shown in FIG. 1D in cross-section 142 with solid insert 25. It would be evident to one of skill in the art that the number of splines/grooves, their location, relative dimensions etc and thereby the corresponding grooves/splines may be varied according to the design and manufacturing requirements of the manufacturer that may be determined by factors including but not limited to the target cost of the club, angular misalignment error acceptable, and material selection for the golf club shaft.

Referring to FIG. 5B there are shown first to third shaft ends 510 to 530 respectively. First end 510 comprising first club shaft 512 and first insert 515 wherein the first club shaft 512 and first insert 515 have inner and outer surfaces that are tapering with reducing diameter for first insert 515 away from the end of the first shaft 512. Second end 520 comprising second club shaft 522 and second insert 525 wherein the second club shaft 522 and second insert 525 have inner and outer surfaces that are of constant diameter away from the end of the second shaft 522. Likewise, third end 530 comprising third club shaft 532 and third insert 535 wherein the third club shaft 532 and third insert 535 have inner and outer surfaces that are of increasing diameter for the third insert 535 away from the end of the third shaft 532. Each of first to third inserts 515 through 535 respectively may have a recess for accepting the fitting of a grip, golf club head hosel, hockey stick blade, etc.

As is evident from the embodiments described above in respect of FIG. 1F and subsequently below in respect of FIGS. 6 to 12 the shaft may vary in geometry throughout its length according to specific design, performance, manufacturing, and aesthetic factors. It may provide keying to one or more other elements of the item of sports equipment in a single alignment or multiple alignments according to the particular design embodiments implemented. Additionally in other designs the shaft is integrated into the item of sports equipment as part of the manufacturing with modifications to the manufacturing to provide for this. For example, a one-piece hockey stick may exploit the techniques, as may a one-piece tennis racket. It would also be evident that where multiple elements are employed that the aligned interface between a shaft and the other element(s) allows for the removal in some designs of epoxy, resin, tape or other materials to prevent rotation as now rotation is mechanically prevented unlike prior art approaches. Whilst epoxy, resin, tape or other materials may be employed to secure the elements of the item of sports equipment to one another, as well as other methods such as mechanical interference, solder, mechanical fixtures etc, the requirements for these may now be considered differently as their primary consideration is towards longitudinal sheer between the elements rather than the inducement of high rotation sheer for example as the golf club head impacts the golf ball twisting the head relative to the shaft or the golfer starts their swing.

Now referring to FIG. 6 there are depicted first and second shafts 600A and 600B for an item of sports equipment according to embodiments of the invention. Each of first and second shafts 600A and 600B employ an inner core 610, intermediate material 620, and outer 630. Considering first shaft 600A then as depicted there are three regions, first and second ends L1A and L5A respectively where the inner core 610, intermediate material 620, and outer 630 are disposed to form solid sections of the first shaft 600A. Then in first and second transitions L2A and L4A the intermediate material 620 tapers down in thickness whilst inner core 610 and outer 630 remain constant wherein, therefore, disposed between these is main section L3A where each of the inner core 610, intermediate material 620, and outer 630 maintain geometry. Accordingly, there is formed therefore between each of the inner core 610 and intermediate material 620 and then the outer 630 two regions without any material between them.

Likewise second shaft 600B begins at one end L5B with the inner core 610, intermediate material 620, and outer 630 all being joined together wherein they then separate in first transition L4B, before running parallel for the central portion L3B of the second shaft 600B. Subsequently second transition L2B tapers the inner core 610, intermediate material 620, and outer 630 back down in overall dimensions to second end L1B. Unlike first end L5B the second end L1B still has each of the inner core 610, intermediate material 620, and outer 630 separated from one another. Such an embodiment for example providing means to using a bladder inflation approach to shape the shaft such as described above.

Referring to FIG. 6B there is depicted the result of a golfer, in this particular example, employing a shaft such as either of first and second shafts 600A and 600B as described supra in FIG. 6 as the speed of their swing increases. At low swing speeds the flexure of the shaft overall is low and inner core 610, intermediate material 620, and outer 630 are essentially concentric still. As the speed increases then shaft flexure increases such that now intermediate material 620 is in contact with the inner surface of the outer 630. Further increased swing speed results in increased flexure and thereby contact of the inner core 610 with the inner surface of the intermediate material 620.

It would be apparent to one skilled in the art that the overall performance of the shaft therefore under differing flexures arises from the combination of the materials employed for each of the inner core 610, intermediate material 620, and outer 630. According to other embodiments the number of layers may be increased or decreased as well as one or more gap between sequential layers being filled with a filler rather than air, a gas or under vacuum.

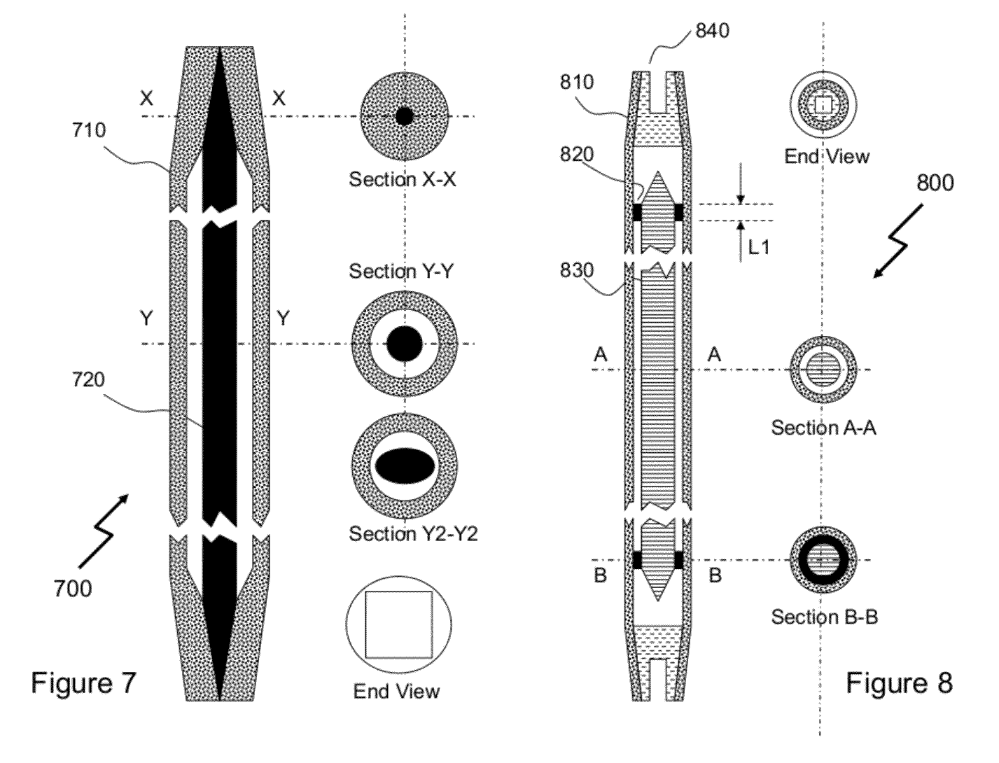

Referring to FIG. 7 there is depicted a shaft 700 for an item of sports equipment according to an embodiment of the invention. Shaft 700 comprising a core 720 and outer 710. Unlike first and second shafts 600A and 600B the core 720 tapers at each end whilst being in contact with the outer 710. Accordingly, whilst forming a co-joined single piece the central portion of the shaft under high deflection is determined increasingly by the core 720 than the outer 710. Also shown in FIG. 7 are cross-sections X-X and Y-Y through the shaft 700 together with an end view depicting an exemplary square cross-section for the ends and circular cross-section for the main portion of the shaft 700.

Also shown is a second central cross-section Y2-Y2 representing an alternate embodiment wherein the core 720 is elliptical in cross-section. It would be understood by one of skill in the art that other geometries of the core 720 and outer 710 may be employed without departing from the scope of the invention.

Now referring to FIG. 8 there is depicted a shaft 800 for an item of sports equipment according to an embodiment of the invention. Now core 820 does not extend the length of the shaft but rather terminates before each end. The core 820 being positioned relative to the outer 810 by spacers 820 at each end of the core 820, each of length L1. Disposed within each end of the shaft 800 are inserts 840 such as described supra in respect of FIG. 5B. As such the low flexure performance of shaft 800 is determined solely primarily by the outer 810 until sufficient flexure is imparted to the shaft 800 for the outer 810 to contact core 830. Sections A-A and B-B through the central region and spacer region of the shaft 800 are shown together with an end view.

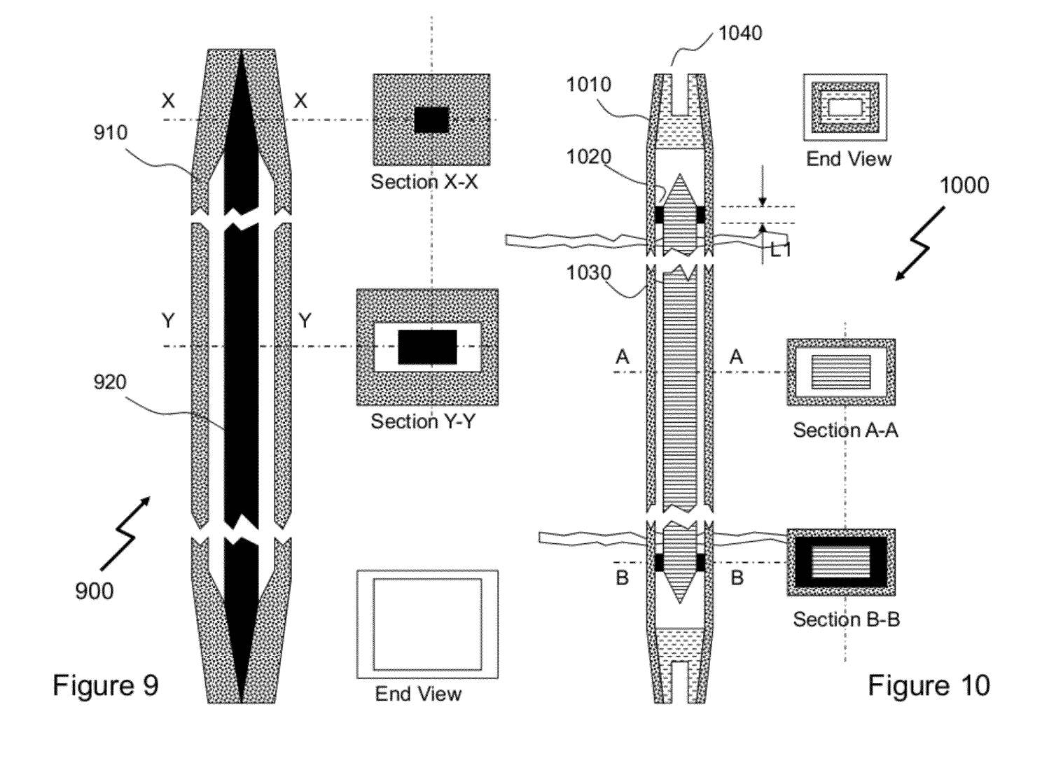

Now referring to FIG. 9 there is depicted a shaft 900 for an item of sports equipment according to an embodiment of the invention. In design shaft 900 is comparable to shaft 700 in FIG. 7 above but now the cross-section of the core 920 and outer 910 are rectangular, as for example would be the case if shaft 900 formed part of a hockey stick for example. Likewise FIG. 10 depicts a shaft 1000 for an item of sports equipment according to an embodiment of the invention having essentially the same construction as shaft 800 in FIG. 8 but the elements are now designed with a rectangular cross-section. It would be apparent to one skilled in the art that other geometries for part or all of the elements would be possible without departing from the scope of the invention. For example core 1030, spacer 1020, and outer 1010 may all be rectangular in overall design whilst the inner geometry of outer 1010 and external geometry of insert 1040 may be circular, square, hexagonal or any other geometry considered appropriate.

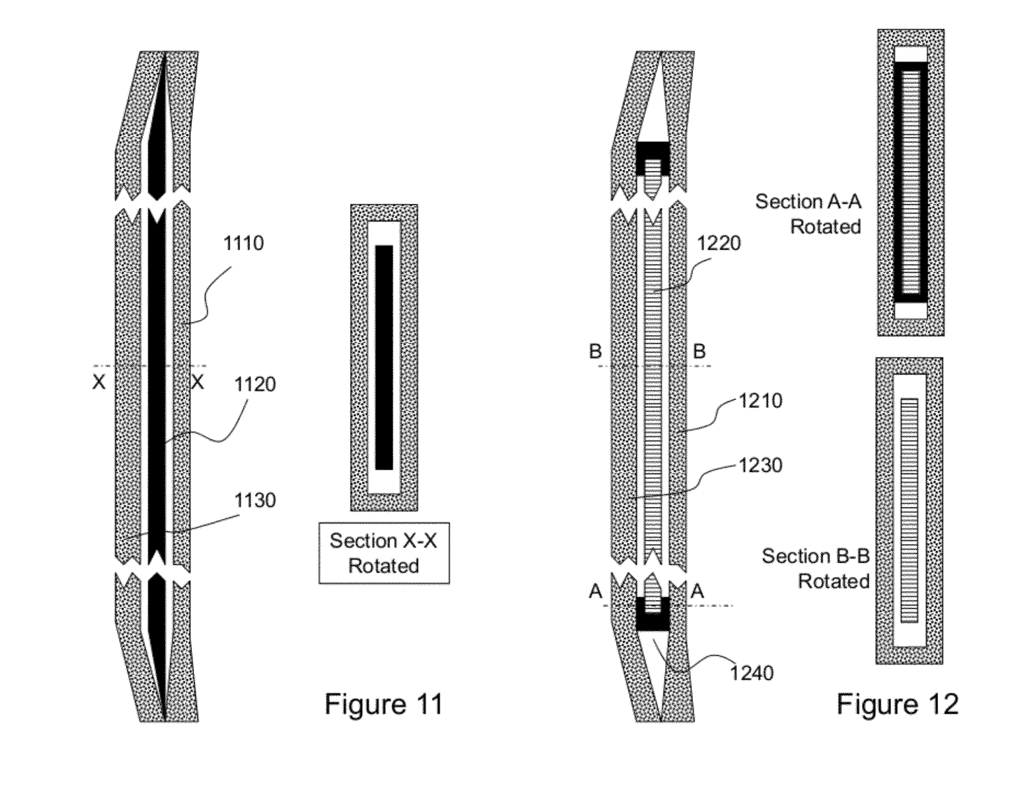

Likewise referring to FIGS. 11 and 12 there are depicted bodies 1100 and 1200 for an item of sports equipment according to embodiments of the invention. As evident from cross-sections X-X and B-B in each respective Figure the cross-section of bodies 1100 and 1200 are elongate rectangular such as for example as may be encountered with skis, snowboards or other such items of sports equipment. Considering body 1100 in FIG. 11 the core 1120 extends the length of the body 1100 but narrows in thickness as it approaches the ends so that it is essentially mounted at the extremes. In contrast body 1200 has the core 1220 mounted by spacers 1240 to fix its position at two points within the outer 1230. Cross-section A-A depicts the spacers 1240 as surrounding the core 1220 within the body 1200.

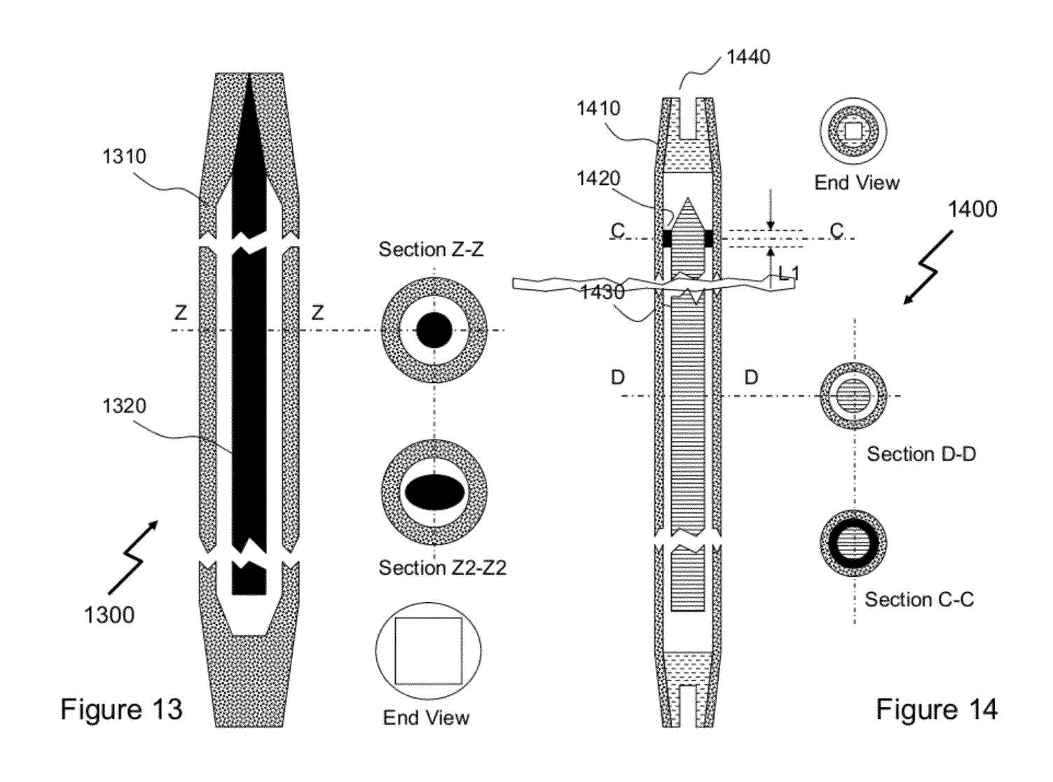

Now referring to FIG. 13 there is depicted a shaft 1300 for an item of sports equipment according to an embodiment of the invention. Shaft 1300 comprising a core 1320 and outer 1310. Unlike shaft 900 in FIG. 9 supra the core 720 tapers at only one end whilst being in contact with the outer 710. At the other end the core 720 floats relative to the outer 710. Accordingly, whilst forming a co-joined single piece at one end the performance of the shaft 1300 under high deflection is determined increasingly by the core 1320 rather than the outer 1310. Also shown in FIG. 13 is cross-section Z-Z through the shaft 1300 at the together with an end view depicting an exemplary square cross-section for the ends and circular cross-section for the main portion of the shaft 1300.

Also shown is a second central cross-section Z2-Z2 representing an alternate embodiment wherein the core 1320 is elliptical in cross-section. It would be understood by one of skill in the art that other geometries of the core 1320 and outer 1310 may be employed without departing from the scope of the invention.

Referring to FIG. 14 there is depicted a shaft 1400 for an item of sports equipment according to an embodiment of the invention. Now core 1420 does not extend the length of the shaft but rather terminates before each end. The core 1420 being positioned relative to the outer 1410 by spacers 1420 at each end of the core 1420, each of length L1. Disposed within each end of the shaft 1400 are inserts 1440 such as described supra in respect of FIG. 5B. As such the low flexure performance of shaft 1400 is determined solely primarily by the outer 1410 until sufficient flexure is imparted to the shaft 1400 for the outer 1410 to contact core 1430. Sections A-A and B-B through the central region and spacer region of the shaft 1400 are shown together with an end view.

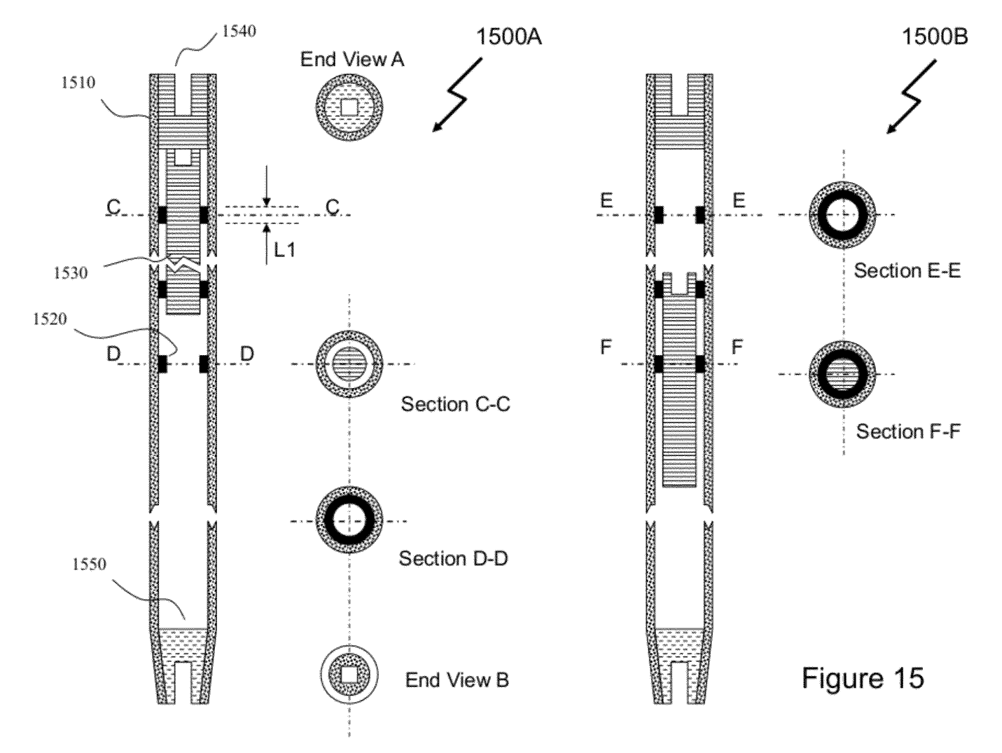

Now referring to FIG. 15 there are depicted first and second cross-sections 1500A and 1500B respectively with respect to an adjustable variable stiffness shaft according to an embodiment of the invention. As described above in respect of FIG. 14 a core 1420 is positioned relative to the outer 1410 and attached at one end by the spacers 1420. Within FIGS. 15 through 17 the fixed core 1420 is replaced by a variable position core and/or insertable core elements. As depicted a shaft 1510 has at one end a first fitting 1550 for coupling to a first element of an item of sports equipment, for example a golf club head hosel, and a second fitting 1540 for coupling to a second element of an item of sports equipment, for example a golf club grip. Disposed within the shaft 1510 are a plurality of mounts 1520 and a rigid element 1530. As depicted in first cross-section 1500A the rigid element 1530 is at one end of the shaft 1510 adjacent the second fitting 1540 whereas in the second cross-section 1500B the rigid element 1530 is disposed down towards the middle of the shaft 1510. Cross-sections C-C, D-D, E-E and F-F depict lateral cross-sections of the shaft in these two positions.

Rigid element 1530 being moved from the first position in first cross-section 1500A to the second position in the second cross-section 1500B through rotation as the outer surface of the rigid element 1530 and the inner surfaces of the plurality of mounts 1520 form a screw thread arrangement. Accordingly a user may adjust the vertical position of the rigid element 1530 within the shaft 1510 such that the rigid element adjusts the rigidity of the shaft 1510 for the user of the item of sports equipment comprising the shaft 1510 in dependence upon the position of the rigid element 1530. Access to the rigid element 1530 to adjust its position being achieved through removal of the second fitting 1540. It would be evident to one skilled in the art that the material or materials forming the rigid element 1530 and the length of the rigid element 1530 may be varied to provide further variations in the performance of the shaft 1510 with the rigid element 1530 inserted. Optionally, the rigid element 1530 may be purchased as an after-sales element and offered in several variants.

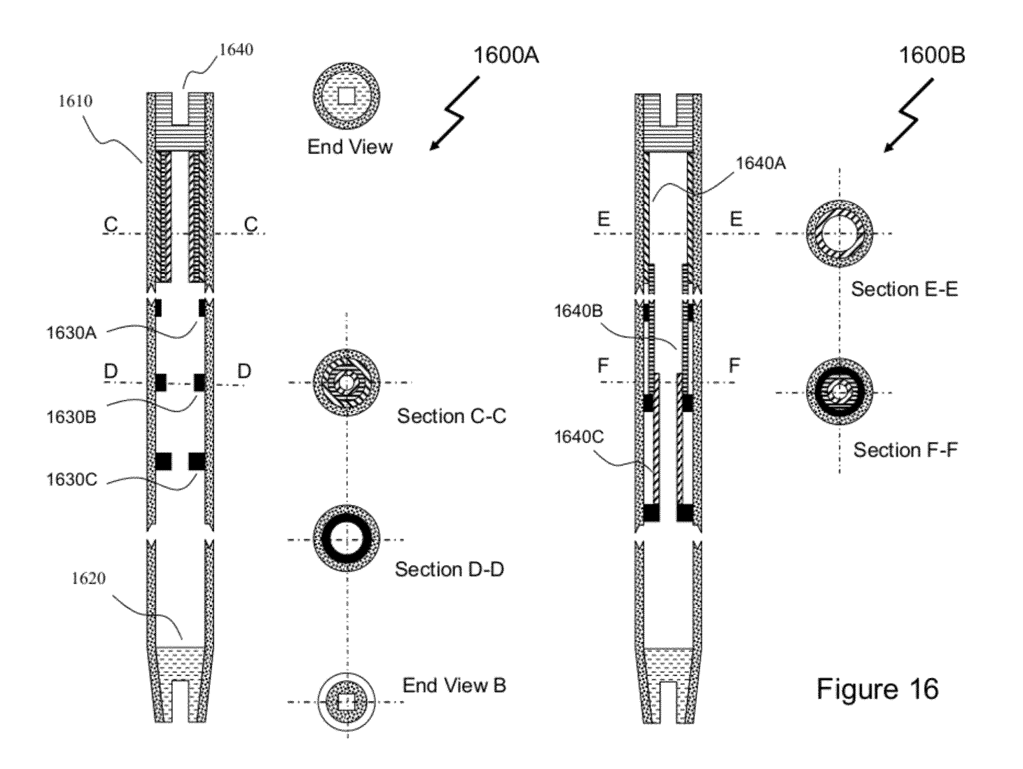

Referring to FIG. 16 there are depicted first and second cross-sections 1600A and 1600B respectively with respect to an adjustable variable stiffness shaft according to an embodiment of the invention. As depicted a shaft 1610 has at one end a first fitting 1620 for coupling to a first element of an item of sports equipment, for example a golf club head hosel, and a second fitting 1640 for coupling to a second element of an item of sports equipment, for example a golf club grip. Disposed within the shaft 1610 are first to third mounts 1630A through 1630C respectively and first to third rigid elements 1640A through 1640C respectively. As depicted in first cross-section 1600A the first to third rigid elements 1640A through 1640C respectively are at one end of the shaft 1610 adjacent the second fitting 1640 whereas in the second cross-section 1600B the first to third rigid elements 1640A through 1640C respectively are disposed along the length of the shaft 1510. First lateral cross-sections C-C shows the first to third rigid elements 1640A through 1640C respectively within the shaft 1610 prior to their deployment whereas second lateral cross-section D-D shows the second mount 1630B within the shaft 1610.

Third and fourth lateral cross-sections E-E and F-F respectively depict lateral cross-sections of the shaft with the first to third rigid elements 1640A through 1640C respectively deployed along the length of the shaft. Deployment of the first to third rigid elements 1640A through 1640C respectively may be achieved for example through mating threaded surfaces on the first to third rigid elements 1640A through 1640C respectively so that rotation of each of the second and third rigid elements 1640B and 1640C respectively within each of the first and second rigid elements 1640A and 1640B respectively. It would be evident to one skilled in the art that other methods of deploying the first to third rigid elements 1640A through 1640C respectively may be employed and that additionally epoxies or other methods may employed to fix the location of the first to third rigid elements 1640A through 1640C respectively in the positions that give the desired performance of the shaft 1610 within the item of sports equipment of which it forms part.

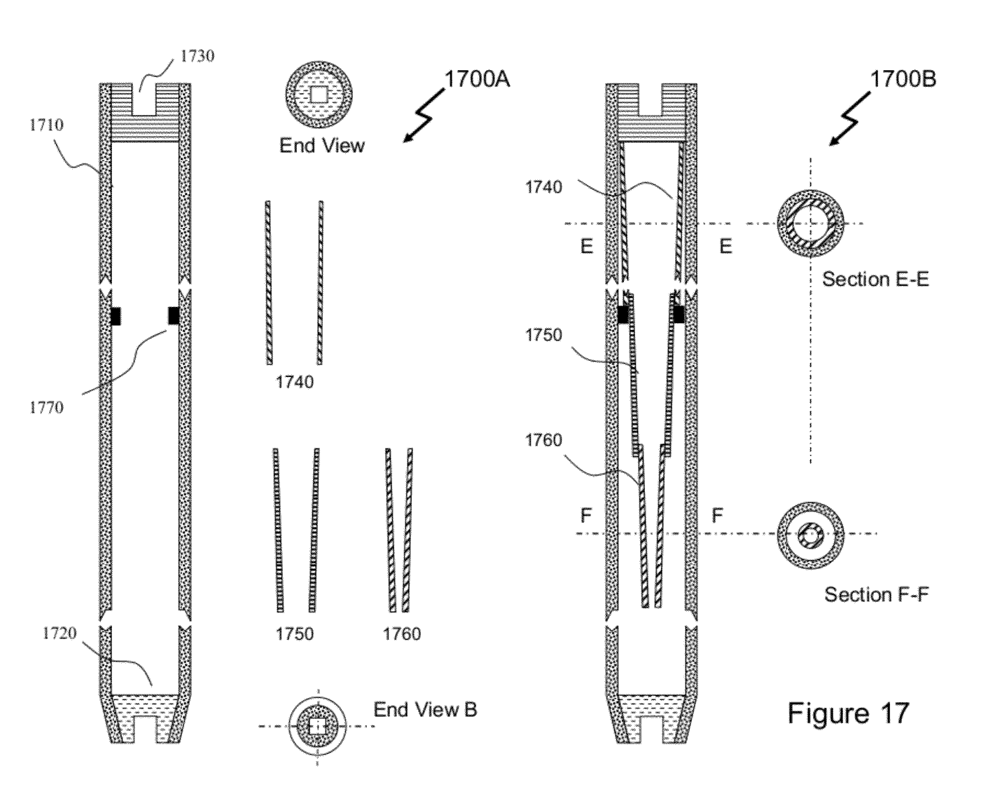

Now referring to FIG. 17 there are depicted first and second cross-sections 1700A and 1700B respectively with respect to an adjustable variable stiffness shaft according to an embodiment of the invention. As depicted a shaft 1710 has at one end a first fitting 1720 for coupling to a first element of an item of sports equipment, for example a golf club head hosel, and a second fitting 1730 for coupling to a second element of an item of sports equipment, for example a golf club grip. Disposed within the shaft 1710 is mount 1770. Also associated with the shaft 1710 are first to third inserts 1740, 1750, and 1760 respectively. Referring to second cross-section 1700B these first to third inserts 1740, 1750, and 1760 respectively are shown inserted within the shaft 1710 wherein the first insert 1740 is stopped by the mount 1770 whereas each of the second and third inserts 1750 and 1760 respectively are stopped by their dimensions within each of the first and second inserts 1740 and 1750 respectively. First and second lateral cross-sections E-E and F-F of the second cross-section 1700B depict the shaft 1710 with the first to third inserts 1740, 1750, and 1760 respectively disposed within.

It would be evident to one skilled in the art that alternate means of disposing of multiple inserts within the shaft of an item of sports equipment may be considered apart from those depicted in respect of FIGS. 15 through 17 with either single or multiple elements. Whilst FIGS. 16 and 17 depict multiple elements disposed from one end of the shaft it would be evident to one skilled in the art that optionally elements may be disposed from both ends according to the design of the shaft and fitting(s) for example. Further, in respect of FIGS. 15 through 17 whilst the embodiments presented are either disposed centrally or peripherally in each instance it would be further evident that the alternate may be employed for each instance without departing from the scope of the invention or optionally both may be employed within a single embodiment.

It would also be apparent that the material or materials for the single or multiple elements depicted in respect of FIGS. 15 through 17 that are disposed within the shaft may be formed from a variety of materials including, but not limited to, composites, fiber loaded composites, plastics, resins, metals, ceramics, and laminates. Optionally, such inserts may have constant spacing from the shaft inner wall or variable spacing from the shaft wall. It would also be evident that whilst the embodiments presented above in respect of FIGS. 15 through 17 are applied to circularly symmetric shafts that the invention may be applied to non-circularly symmetric shafts as well as shafts of arbitrary cross-section as employed in a variety of different sports.

It would be apparent to one skilled in the art that the embodiments presented supra in respect of FIGS. 5 through 17 may be implemented using a variety of materials and manufacturing techniques including, but not limited to, those described in respect of FIGS. 1A through 1F and 2. Additionally the shafts may be formed discretely for subsequent attachment of other elements of the item of sports equipment or may be manufactured integrally to some or all of these other elements of the item of sports equipment according to a variety of factors including, but not limited to, the particular item, the manufacturing techniques, commercial factors etc.

The single ended attachment presented in FIGS. 13 and 14 may be applied to shafts of varying cross-section, including those for equipment such as snowboards and skis for example. Additionally, the elements may be joined at the end of the shaft forming or nearest the grip or handle in some instances or at the end with the head of the item of sports equipment. In equipment such as skis and snowboards the location of the shaft ends, joined and unjoined, relative to the distal ends of equipment may be established by other considerations. The separation between elements such as core 1320 and outer 1310 may also be varied such as shown by cross-sections Z-Z and Z2-Z2 in FIG. 13. Alternatively, the separation in one axis or in multiple axes may be reduced substantially or eliminated thereby providing asymmetry in the axial performance of the shaft with respect to different axes. Such variations being additional to those arising from the specific cross-sections of the different elements as well as those from the materials employed or their manufacturing method.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a component comprising a shaft of length substantially larger than its lateral dimensions having at one end a handle and at the other distal end a head, the shaft comprising:
an outer body formed from a first material characterized by at least a first Young's modulus;
an inner body formed from a second material characterized by at least a second Young's modulus; wherein
the outer body has a length at least one of equal to and greater than the inner body and is separated from the inner body over a predetermined portion of the length of the shaft such that the shaft exhibits a first stiffness under first motion of the component and a second stiffness under second motion of the component.

2. The method according to claim 1 wherein;
the component is at least one of a golf club, a tennis racket, a badminton racket, a squash racket, an ice hockey stick, a field hockey stick, a lacrosse stick, a hurling stick, a ski pole, a ski, a snowboard, and a skateboard.

3. The method of claim 1 wherein,
at least one of the head and handle are demountably attached to the shaft wherein a predetermined portion of the appropriate distal end of the shaft and a predetermined portion of the at least one comprise complementary surfaces to align the at least one of in a predetermined orientation to a predetermined axis of the shaft.

4. The method of claim 1 wherein,
at least one of the outer body and inner body have a predetermined cross-section, the predetermined cross section at least one of a predetermined portion of a regular polygon, semi-circular, elliptical, and truncated circular profile.

5. The method of claim 1 wherein;
at least one of the outer body and inner body are formed from at least a first material, the first material selected from the group comprising carbon, titanium, boron, tungsten, glass fiber, steel, stainless steel, iron, resin, a plastic in sheet form, aramid synthetic fibers, epoxy, a thermoplastic, a thermosetting resin, and a wax.

6. The method of claim 5 wherein,
the shaft is formed from a plurality of layers containing fibers of the first material, wherein at least a pair of adjacent layers within the plurality of layers have the fibers orientated at different angular orientations to the longitudinal axis of the shaft.

8. The method of claim 1 wherein,
the outer body is manufactured by at least one of a molding process, a hydroforming process, and a process employing a mandrel to form the shaft upon.

9. A device comprising:
a handle;
a head;
a shaft of length substantially larger than its lateral dimensions having at one end the handle and at the other distal end the head, the shaft comprising:
an outer body formed from a first material characterized by at least a first Young's modulus;
an inner body formed from a second material characterized by at least a second Young's modulus; wherein
the outer body has a length at least one of equal to and greater than the inner body and is separated from the inner body over a predetermined portion of the length of the shaft such that the shaft exhibits a first stiffness under first motion of the component and a second stiffness under second motion of the component.

10. The method according to claim 9 wherein;
the component is at least one of a golf club, a tennis racket, a badminton racket, a squash racket, an ice hockey stick, a field hockey stick, a lacrosse stick, a hurling stick, a ski pole, a ski, a snowboard, and a skateboard.

11. The method of claim 9 wherein,
at least one of the head and handle are demountably attached to the shaft wherein a predetermined portion of the appropriate distal end of the shaft and a predetermined portion of the at least one comprise complementary surfaces to align the at least one of in a predetermined orientation to a predetermined axis of the shaft.

12. The method of claim 9 wherein,
at least one of the outer body and inner body have a predetermined cross-section, the predetermined cross section at least one of a predetermined portion of a regular polygon, semi-circular, elliptical, and truncated circular profile.

13. The method of claim 9 wherein;
at least one of the outer body and inner body are formed from at least a first material, the first material selected from the group comprising carbon, titanium, boron, tungsten, glass fiber, steel, stainless steel, iron, resin, a plastic in sheet form, aramid synthetic fibers, epoxy, a thermoplastic, a thermosetting resin, and a wax.

14. The method of claim 9 wherein,
the shaft is formed from a plurality of layers containing fibers of the first material, wherein at least a pair of adjacent layers within the plurality of layers have the fibers orientated at different angular orientations to the longitudinal axis of the shaft.

15. The method of claim 9 wherein,
the outer body is manufactured by at least one of a molding process, a hydroforming process, and a process employing a mandrel to form the shaft upon.

16. A method comprising:
providing a shaft of length substantially larger than its lateral dimensions to support at one end a handle and at the other distal end a head, the shaft comprising:
an outer body formed from a first material characterized by at least a first Young's modulus;
an inner body formed from a second material characterized by at least a second Young's modulus; wherein
the outer body has a length at least one of equal to and greater than the inner body and is separated from the inner body over a predetermined portion of the length of the shaft such that the shaft exhibits a first stiffness under first motion of the component and a second stiffness under second motion of the component.

17. The method according to claim 16 wherein,
at least one of the outer body and inner body are formed from at least a first material, the first material selected from the group comprising carbon, titanium, boron, tungsten, glass fiber, steel, stainless steel, iron, resin, a plastic in sheet form, aramid synthetic fibers, epoxy, a thermoplastic, a thermosetting resin, and a wax.
